(19) United States
(12) Patent Application Publication
(10) Pub. No.: US 2025/0380279 A1
(43) Pub. Date: Dec. 11, 2025

(54) CONFIGURED GRANT ENHANCEMENT FOR SIDELINK COMMUNICATIONS IN UNLICENSED SPECTRUM

(71) Applicant: QUALCOMM Incorporated, San Diego, CA (US)

(72) Inventors: Chih-Hao LIU, San Diego, CA (US); Sherif ELAZZOUNI, San Diego, CA (US); Rajat PRAKASH, San Diego, CA (US); Jing SUN, San Diego, CA (US); Giovanni CHISCI, San Diego, CA (US); Shaozhen GUO, Beijing (CN); Xiaoxia ZHANG, San Diego, CA (US); Yisheng XUE, San Diego, CA (US)

(21) Appl. No.: 18/874,415

(22) PCT Filed: Aug. 11, 2022
(86) PCT No.: PCT/CN2022/111701

§ 371 Date: Dec. 12, 2024

(51) Int. Cl. H04W 72/25; H04W 74/0808

(52) U.S. Cl. CPC H04W 72/25; H04W 74/0808

(57) ABSTRACT

Apparatus, methods, and computer-readable media for on-demand sensing based on sidelink resource reevaluation are disclosed herein. An example method of wireless communication performed by a user equipment includes receiving, from a base station, a resource grant indicating a plurality of resources for sidelink communication on at least one sidelink channel for a configured period of time, in which the plurality of resources includes a plurality of allocated slots and one or more candidate transmission slots associated with respective ones of the plurality of allocated slots for additional opportunities of a listen-before-talk (LBT) procedure on the at least one sidelink channel. The method also includes transmitting, to the base station, an indication of at least one status associated with the LBT procedure used on the at least one sidelink channel.

### BACKGROUND

### Technical Field

The present disclosure generally relates to communication systems, and more particularly, to configured grant enhancement for sidelink communications in unlicensed spectrum.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Aspects of wireless communication may include direct communication between devices, such as in V2X and/or other D2D communication. There exists a need for further improvements in V2X and/or other D2D technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a base station, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel. The apparatus is also configured to transmit, to the base station, an indication of at least one status associated with the LBT procedure used on the at least one sidelink channel.

In another aspect of the disclosure, a method, a computer-readable medium, and an apparatus are provided. The apparatus is configured to transmit, to a user equipment (UE), a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a LBT procedure on the at least one sidelink channel. The apparatus is also configured to receive, from the UE, an indication of at least one status associated with the LBT procedure used on the at least one sidelink channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with aspects presented herein.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 illustrates example aspects of a sidelink slot structure.

FIG. 4 is a block diagram of a base station in communication with a UE in an access network.

FIG. 5 illustrates an example of an allocation of slots and subchannels in a resource pool.

FIG. 6 illustrates an example of a resource pool including resource reservations for a sidelink data transmission.

FIG. 7 is a diagram illustrating an example of sidelink communications and access link communications, in accordance with various aspects of the present disclosure.

FIG. 8 is a diagram illustrating an example of sidelink communications, in accordance with various aspects of the present disclosure.

FIG. 9 is a diagram illustrating an example of acknowledgement messages for sidelink channels, in accordance with various aspects of the present disclosure.

FIG. 10 is a diagram illustrating an example associated with listen-before-talk (LBT) reporting for sidelink channels, in accordance with various aspects of the present disclosure.

FIG. 11 illustrates an example of sidelink communication based on mode 1 resource allocation, in accordance with various aspects of the present disclosure.

FIG. 12 illustrates an example of sidelink communication based on mode 1 resource allocation with configured grant enhancement, in accordance with various aspects of the present disclosure.

FIG. 13 illustrates another example of sidelink communication based on mode 1 resource allocation with configured grant enhancement, in accordance with various aspects of the present disclosure.

FIG. 14 is a flowchart of a process of wireless communication, in accordance with various aspects of the present disclosure.

FIG. 15 is a flowchart of a process of wireless communication, in accordance with various aspects of the present disclosure.

FIG. 16 is a diagram illustrating an example of a hardware implementation for an apparatus, in accordance with various aspects of the present disclosure.

FIG. 17 is a diagram illustrating an example of a hardware implementation for an apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

A transmitter user equipment (e.g., Tx UE) can transmit feedback (if configured) in an uplink control channel configured after a sidelink feedback channel is associated with a last sidelink data resource allocated for each configured grant period. The feedback report may include information of an initial transmission and one or more retransmissions of a same transport block. In some aspects, the Tx UE may report a positive acknowledgment in the uplink control channel only if all receiver UEs (e.g., Rx UEs) receive correctly at least one of the retransmissions and the Rx UEs positively acknowledge reception of the retransmissions to the Tx UE. When the feedback report includes information of the transmission and retransmissions of different transport blocks, the Tx UE may only report a positive acknowledgment if all Rx UEs receive correctly the different transport blocks and the Rx UEs positively acknowledge reception of the different transport blocks to the Tx UE. In sidelink mode 1 operation for the unlicensed spectrum, a negative acknowledgment in the uplink control channel may not reflect whether the negative acknowledgment is due to a listen-before-talk (LBT) failure or a decoding failure. Some legacy techniques provide for reporting the LBT failure directly to the base station by reusing the uplink control channel resource allocated for feedback reporting in the sidelink mode 1 operation.

However, for unlicensed spectrum operation, sidelink transmission is subject to the LBT status, hence, multiple transmission opportunities for configured grant may be needed. In NR unlicensed spectrum (NR-U) operation, the mechanisms used for both configured grant Type 1 and configured grant Type 2 can be extended so that the number of allocated slots following a time instance corresponding to an indicated configured grant offset can be configured to provide additional LBT opportunities. Although the legacy sidelink operation provides for up to three sidelink data resources within one configured grant period, at least two sidelink data resources may need to be spaced out to allow the sidelink feedback channel to be located in the middle for feedback. As such, for sidelink unlicensed spectrum (SL-U) operation, there exists a need to introduce additional LBT opportunities.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

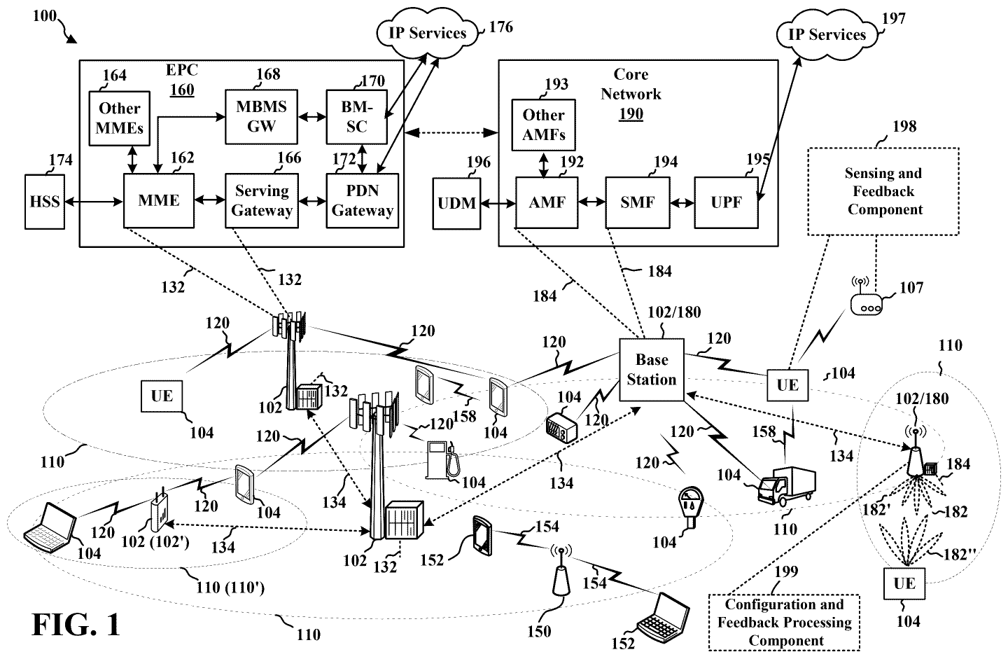

FIG. 1 is a diagram illustrating an example of a wireless communications system and an access network 100 including device(s) configured to perform the resource reevaluation aspects described herein. Some wireless communication may be exchanged directly between wireless devices based on sidelink. The communication may be based on vehicle-to-anything (V2X) or other device-to-device (D2D) communication, such as Proximity Services (ProSe), etc. Sidelink communication may be exchanged based on a PC5 interface, for example.

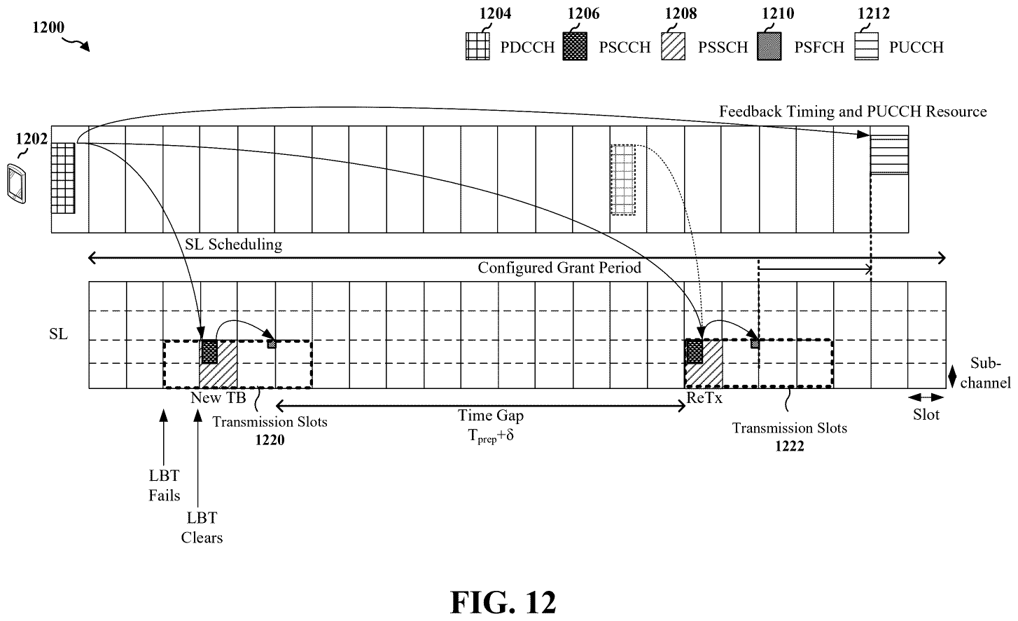

As described above, for unlicensed spectrum operation, sidelink transmission is subject to the LBT status, hence, multiple transmission opportunities for configured grant may be needed. In some examples, a UE 104 may be configured to manage one or more aspects of wireless communication by facilitating configured grant enhancement for sidelink communications in unlicensed spectrum. As an example, in FIG. 1, the UE 104, the RSU 107, and/or other devices communicating based on sidelink may include a sensing and feedback component 198 configured to receive, from a base station, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel. The sensing and feedback component 198 is also configured to transmit, to the base station, an indication of at least one status associated with the LBT procedure used on the at least one sidelink channel. Further related aspects and features are described in more detail in connection with FIGS. 12-15.

Although the following description may be focused on 5G NR, the concepts described herein may be applicable to other similar areas, such as LTE, LTE-A, CDMA, GSM, and other wireless technologies.

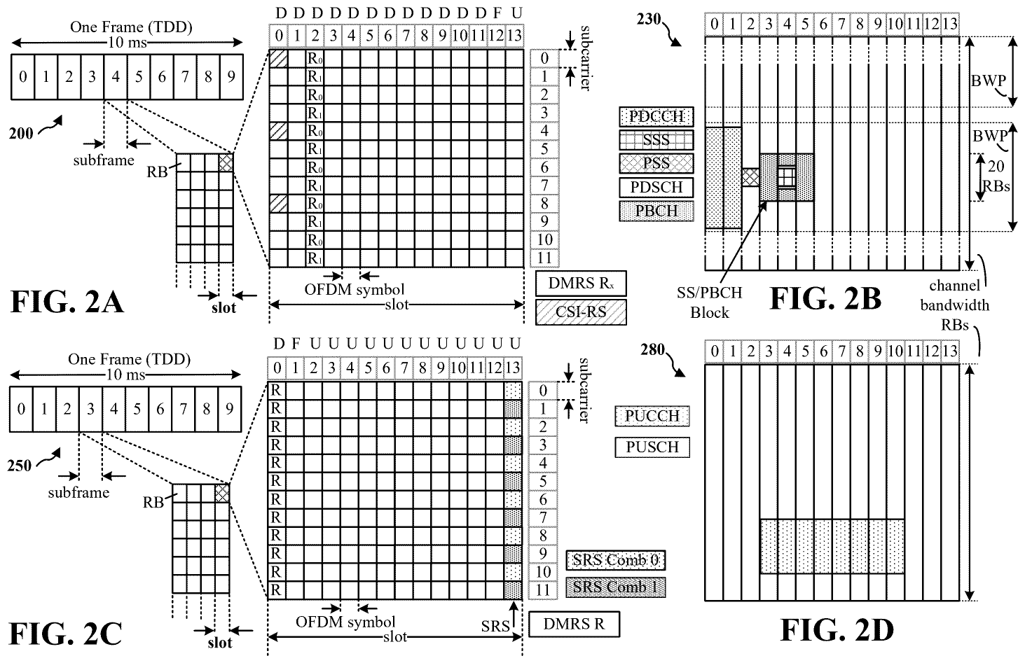

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2X or other D2D communication, such as Proximity Services (ProSe), etc. Communication based on V2X and/or D2D may also be transmitted and received by other transmitting and receiving devices, such as Road Side Unit (RSU) 107, etc. Aspects of the communication may be based on PC5 or sidelink communication e.g., as described in connection with the example in FIG. 2. Although the following description may provide examples for V2X/D2D communication in connection with 5G NR, the concepts described herein may be applicable to other similar areas, such as LTE, LTE-A, CDMA, GSM, and other wireless technologies.

The wireless communications system and access network 100 in FIG. 1 (also referred to as a wireless wide area network (WWAN)) includes base stations 102, UEs 104, an Evolved Packet Core (EPC) 160, and a Core Network (e.g., 5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for NR (collectively referred to as Next Generation RAN (NG-RAN)) may interface with Core Network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or Core Network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 50 GHz to 500 GHz and a wavelength between 1 millimeter and 10 millimeters. Radio waves in the band may be referred to as a millimeter wave. Near mmW may extend down to a frequency of 5 GHz with a wavelength of 100 millimeters. The super high frequency (SHF) band extends between 5 GHz and 50 GHZ, also referred to as centimeter wave. Communications using the mmW/near mmW radio frequency band has extremely high path loss and a short range. The mmW base station 180 may utilize beamforming 182 with the UE 104 to compensate for the extremely high path loss and short range.

Devices may use beamforming to transmit and receive communication. For example, FIG. 1 illustrates that a base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The Core Network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the Core Network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or Core Network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring back to FIG. 1, a BS 102/180 may be configured to manage one or more aspects of wireless communication by facilitating configured grant enhancement for sidelink communications in unlicensed spectrum. As an example, in FIG. 1, the BS 102, the base station 180, and/or other devices communicating with sidelink devices may include a configuration and feedback processing component 199 configured to transmit, to a user equipment (UE), a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a LBT procedure on the at least one sidelink channel. The configuration and feedback processing component 199 is also configured to receive, from the UE, an indication of at least one status associated with the LBT procedure used on the at least one sidelink channel.

Further, although the present disclosure may focus on vehicle-to-pedestrian (V2P) communication and pedestrian-to-vehicle (P2V) communication, the concepts and various aspects described herein may be applicable to other similar areas, such as D2D communication, IoT communication, vehicle-to-everything (V2X) communication, or other standards/protocols for communication in wireless/access networks.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 5 being configured with slot format 54 (with mostly UL). While subframes 5, 4 are shown with slot formats 54, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}* 15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100ₓ is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

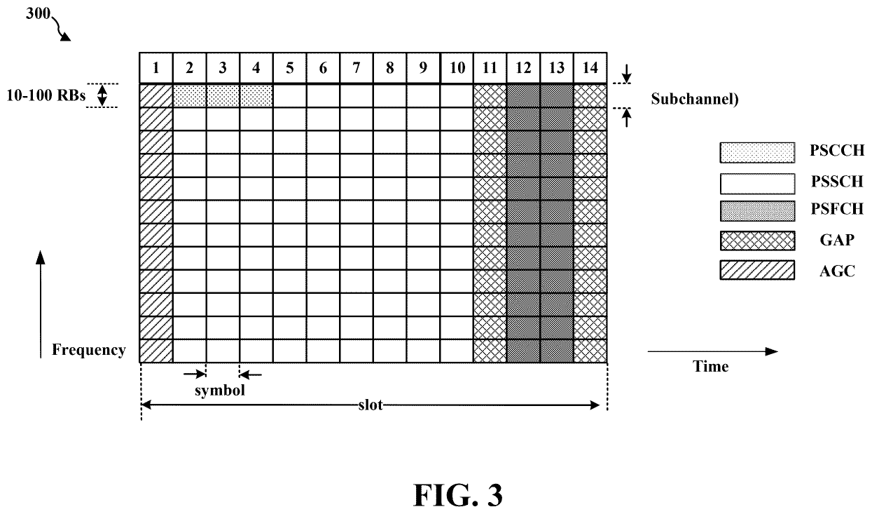

FIG. 3 illustrates example diagram 300 illustrating non-limiting examples of time and frequency resources that may be used for wireless communication based on sidelink. In some examples, the time and frequency resources may be based on a slot structure. In other examples, a different structure may be used. The slot structure may be within a 5G/NR frame structure in some examples. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI).

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. Diagram 300 also illustrates multiple subchannels, where each subchannel may include multiple RBs. For example, one subchannel in sidelink communication may include 10-100 RBs. The PSCCH may be configured (or pre-configured) to occupy 10, 12, 15, 20, 25, or other number of PRBs in a single subchannel. The PSCCH duration may also be configured (or pre-configured) to be 2, 3, or other number of symbols. Moreover, a subchannel may occupy 10, 15, 20, 25, 50, 75, 100, or other number of PRBs. The number of subchannels in a resource pool (RP) may be anywhere including or between 1 to 27 subchannels or other number.

As illustrated in FIG. 3, the first symbol of a subframe may be a symbol for automatic gain control (AGC). Some of the REs may include control information, e.g., along with PSCCH and/or PSSCH. The control information may include Sidelink Control Information (SCI). For example, the PSCCH can include a first-stage SCI. A PSCCH resource may start at a first symbol of a slot, and may occupy 1, 2 or 5 symbols. The PSCCH may occupy up to one subchannel with the lowest subcarrier index. FIG. 3 also illustrates symbol(s) that may include PSSCH. The symbols in FIG. 3 that are indicated for PSCCH or PSSCH indicate that the symbols include PSCCH or PSSCH REs. Such symbols corresponding to PSSCH may also include REs that include a second-stage SCI and/or data. At least one symbol may be used for feedback (e.g., PSFCH), as described herein. As illustrated in FIG. 3, symbols 12 and 13 are indicated for PSFCH, which indicates that these symbols include PSFCH REs. In some aspects, symbol 12 of the PSFCH may be a duplication of symbol 13. A gap symbol prior to and/or after the feedback may be used for turnaround between reception of data and transmission of the feedback. As illustrated in FIG. 3, symbol 10 includes a gap symbol to enable turnaround for feedback in symbol 11. Another symbol, e.g., at the end of the slot (symbol 14) may be used as a gap. The gap enables a device to switch from operating as a transmitting device to prepare to operate as a receiving device, e.g., in the following slot. Data may be transmitted in the remaining REs, as illustrated. The data may include the data message described herein. The position of any of the PSCCH, PSSCH, PSFCH, and gap symbols may be different than the example illustrated in FIG. 3.

Resource allocation for sidelink transmissions may be performed under different modes. In one mode (mode 1 resource allocation), the base station may provide a DCI that assigns the Tx UE the resources for sidelink communications. The DCI may have the DCI format 3_0, for example. In another mode (mode 2 resource allocation), the Tx UE autonomously decides the resources for sidelink communication. The Rx UE may receive sidelink communications from the Tx UE in the configured resource allocation similarly in either mode.

In mode 1 resource allocation, the DCI format 3_0 may indicate a resource allocation for a sidelink data transmission through one or more parameters. For instance, the DCI may include a resource pool index identifying the resource pool for the sidelink data transmission. The resource pool index field may have a number of bits depending on a number of resource pools configured by the base station (e.g., in a parameter sl-TxPoolScheduling or some other name). The DCI may also include a time gap indicating a number of slots after reception of the DCI which the Tx UE waits before sending the sidelink data transmission (e.g., to allow the Rx UE sufficient time to decode the DCI). The time gap field may have a fixed number of bits and a configurable value by the base station (e.g., in a parameter sl-DCI-ToSL-Trans or some other name). The DCI may also include other parameters including, but not limited to, a HARQ process#, a NDI indicating whether the sidelink data transmission is a first transmission or a re-transmission, SCI-1-A format fields indicating the time/frequency resources for the sidelink data transmission (e.g., a TDRA, an FDRA, and a lowest subchannel index for allocation in the frequency domain), a PSFCH to HARQ feedback timing between when the Tx UE receives PSFCH feedback from the Rx UE and sends PUCCH to the base station indicating whether the Rx UE successfully received the sidelink data transmission, a PUCCH resource indicator (PRI) for the PUCCH to the base station, and a configuration index for a periodic resource grant indicating the configured resources which are applied for the sidelink transmission when the DCI is not a dynamic (one-shot) grant but rather a configured grant.

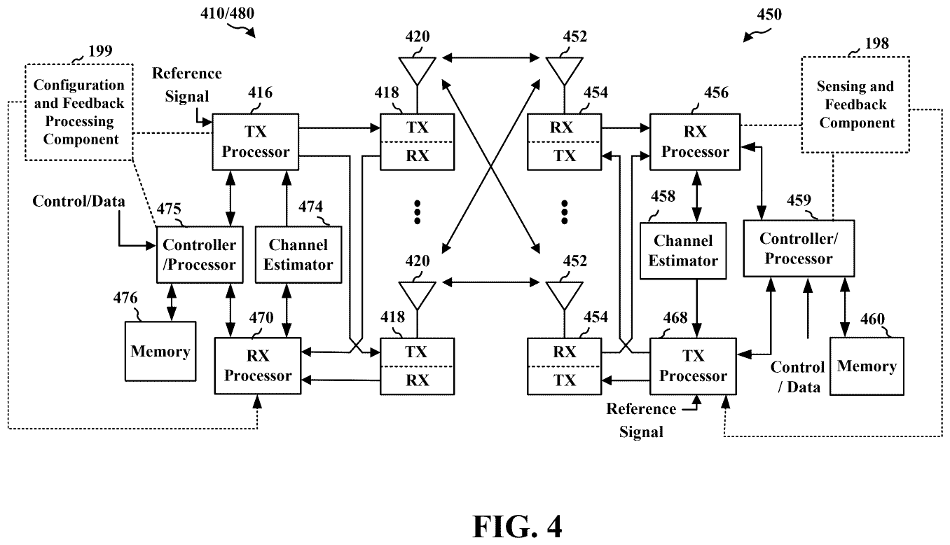

FIG. 4 is a block diagram of a base station 410 in communication with a UE 450 in an access network. In the DL, IP packets from the EPC 160 may be provided to a controller/processor 475. The controller/processor 475 implements layer 4 and layer 2 functionality. Layer 4 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the device 450. Each spatial stream may then be provided to a different antenna 420 via a separate transmitter 418TX. Each transmitter 418TX may modulate an RF carrier with a respective spatial stream for transmission.

At the device 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the device 450. If multiple spatial streams are destined for the device 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 410. These soft decisions may be based on channel estimates computed by the channel estimator 458. The soft decisions are then decoded and deinterleaved to recover the data and control signals that were originally transmitted by device 410 on the physical channel. The data and control signals are then provided to the controller/processor 459, which implements layer 4 and layer 2 functionality.

The controller/processor 459 can be associated with a memory 460 that stores program codes and data. The memory 460 may be referred to as a computer-readable medium. The controller/processor 459 may provide demultiplexing between transport and logical channels, packet reassembly, deciphering, header decompression, and control signal processing. The controller/processor 459 is also responsible for error detection using an ACK and/or NACK protocol to support HARQ operations.

Similar to the functionality described in connection with the transmission by device 410, the controller/processor 459 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by device 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The UL transmission is processed at the device 410 in a manner similar to that described in connection with the receiver function at the device 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. The controller/processor 475 provides demultiplexing between transport and logical channels, packet reassembly, deciphering, header decompression, control signal processing to recover IP packets from the UE 550. IP packets from the controller/processor 575 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with 198 of FIG. 1.

At least one of the TX processor 416, the RX processor 470, and the controller/processor 475 may be configured to perform aspects in connection with 199 of FIG. 1.

In other implementations, a first wireless communication device 480 is in communication with the second wireless communication device 450, e.g., via V2X or other D2D communication. The communication may be based, e.g., on sidelink using a PC5 interface. Each of the first wireless communication device 480 and the second wireless communication device 450 may include a UE, an RSU, or the like.

Generally, in sidelink communications, the first wireless communication device 480 (e.g., a Tx UE) initially achieves sidelink synchronization with the second wireless communication device 450 (e.g., a Rx UE). Following synchronization, the Tx UE may obtain an allocation of time-frequency resources, e.g., one or more slots, RBs, or subchannels in a resource pool, in which to transmit sidelink data to the Rx UE. One subchannel includes at least 10 or some other number of consecutive, non-overlapping RBs. Typically, the resource allocation may be scheduled by a base station in downlink control information (DCI) (in a mode 1 resource allocation), or the resource allocation may be determined through a sensing procedure conducted autonomously by the Tx UE (in a mode 2 resource allocation). After determining the resources, the Tx UE may send sidelink control information (SCI) including the resource allocation in a physical sidelink control channel (PSCCH) to the Rx UE. The Tx UE may transmit the SCI in two stages, including a first-stage SCI (also referred to as SCI-1) carried on PSCCH, and a second-stage SCI (also referred to as SCI-2) carried on a physical sidelink shared channel (PSSCH). SCI-1 may contain information about the resource allocation, while SCI-2 may carry information for identifying and decoding the sidelink data (e.g., a modulation and coding scheme (MCS)). The Tx UE may transmit the sidelink data in the PSSCH to the Rx UE in the allocated resources.

Upon receiving the sidelink transmission, the Rx UE may attempt to blindly decode the PSCCH in all of the allocated subchannels of the resource pool. Typically, the number of allocated subchannels in the resource pool is small (e.g., 1-27 sub-channels), allowing blind decoding to be feasible. If the Rx UE successfully decodes the PSCCH, the UE may also attempt to decode the PSSCH scheduled by the PSCCH for the sidelink data. Depending on the decoding result, the Rx UE may provide hybrid automatic repeat request (HARQ) acknowledgment/negative acknowledgment (ACK/NACK) feedback to the Tx UE in a physical sidelink feedback channel (PSFCH). For example, if the Rx UE failed to decode the sidelink data, the UE may provide NACK to the Tx UE, while if the Rx UE successfully decoded the sidelink data, the UE may provide ACK to the Tx UE. If the Tx UE receives NACK from the Rx UE, the Tx UE may retransmit the sidelink data. Otherwise, if the Tx UE receives ACK from the Rx UE, the Tx UE may transmit new data to the Rx UE, or transmit data to a different Rx UE.

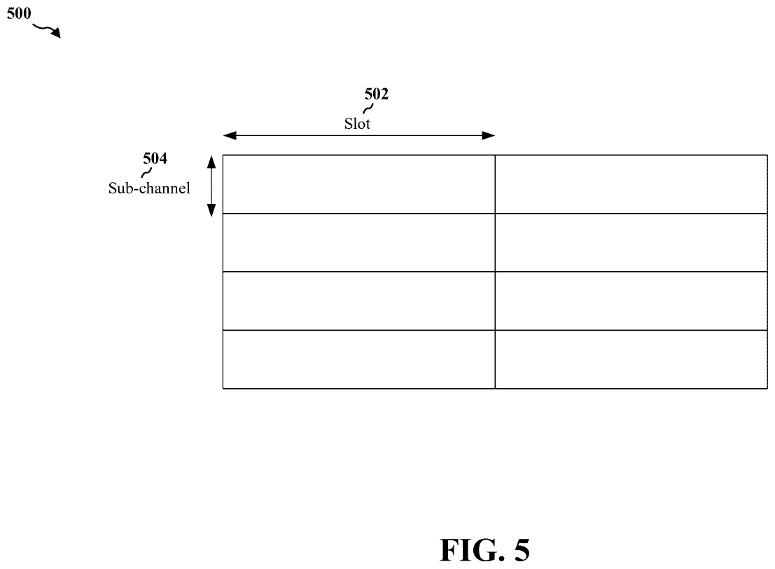

FIG. 5 illustrates an example 500 of an allocation of slots 502 and subchannels 504 in a resource pool. The Tx UE may transmit PSCCH and PSSCH within a same slot. While PSSCH may occupy up to a configured number of contiguous subchannels

$${N}_{s u b c h a nnel}^{SL}$$

in a slot, PSCCH may only occupy up to one subchannel with the lowest subchannel index in the slot. For instance, in the example of FIG. 5, PSCCH may occupy sub-channel 504 (e.g., the top-left illustrated subchannel corresponding to the lowest subchannel index) in slot 502. The Tx UE may transmit SCI-1 in the PSCCH, which may contain information about the PSSCH bandwidth and configured resource reservations in subsequent slots. The Tx UE may also transmit SCI-2 in the PSSCH, which may contain information such as the source identifier (source ID) and destination identifier (destination ID) of a sidelink packet carried in the PSSCH. Upon receiving the sidelink transmission, the Rx UE may blindly decode each sub-channel of a slot for the PSCCH. After decoding PSCCH, the Rx UE may decode PSSCH to distinguish whether the sidelink packet is intended for the Rx UE or another UE, and to identify the Tx UE which sent the packet.

When the Tx UE transmits SCI-1, the SCI-1 may indicate a number and location of resource reservations for the PSSCH. For instance, SCI-1 may indicate a frequency domain resource allocation (FDRA) and a time domain resource allocation (TDRA) indicating the sub-channel(s) and slot(s) which are reserved for the sidelink data transmission. The FDRA and TDRA may each be a field of SCI-1, where each field may include a different numbers of bits depending on the number of configured reservations for the sidelink transmission. For example, in FDRA, the number of bits in the FDRA field may be

$$⌈ log \frac{{N}_{subchannel}^{SL} ( {N}_{subchannel}^{SL} + 1 )}{2} ⌉$$

or some other number for two reservations, and

$$⌈ log \frac{{N}_{subchannel}^{SL} ( {N}_{subchannel}^{SL} + 1 ) ( 2 {N}_{subchannel}^{SL} + 1 )}{6} ⌉$$

or some other number for three reservations. The value of the bits in the FDRA may indicate the sub-channel(s) and RBs in the resource pool which are allocated for the sidelink data. Similarly, in TDRA, the number of bits may be 5 or some other number for two reservations, and 9 or some other number for three reservations. The value of the bits in the TDRA indicates the slot(s) and symbols in the resource pool which are allocated for the sidelink data.

SCI-1 may also include various other fields in addition to the TDRA and FDRA. For instance, SCI format 1-A in PSCCH may indicate at least the following information: a priority associated with the PSSCH transmission and having a fixed number of bits (e.g., 3 bits or some other number), a FDRA whose number of bits depends on a number of slot reservations and a number of subchannels such as previously described, a TDRA whose number of bits depends on a number of reservations such as previously described (e.g., 5 bits for 2 reservations and 9 bits for 3 reservations), a resource reservation period whose number of bits depend on a number of allowed periods, a DMRS pattern whose number of bits depends on a number of configured patterns, a SCI-2 format having a fixed number of bits (e.g., 2 bits or some other number), a beta offset for SCI-2 rate matching having a fixed number of bits (e.g., 2 bits or some other number), a DMRS port having a number of bits (e.g., 1 bit or some other number) indicating a number of data layers for the PSSCH (e.g., one or two data layers), a MCS having a fixed number of bits (e.g. 5 bits or some other number), an additional MCS table having a fixed number of bits (e.g., 0-2 bits or some other range), a PSFCH overhead indicator having a fixed number of bits (e.g., 0 or 1 bit or some other number), and reserved bits for use by the upper layer. The Rx UE may decode SCI-1 to determine this information and receive the PSSCH. Moreover, when the resources allocated in the SCI-1 are autonomously determined by the Tx UE (in mode 2 resource allocation), the Rx UE and other sidelink UEs may decode the SCI-1 in order to perform channel sensing and to avoid resource collision.

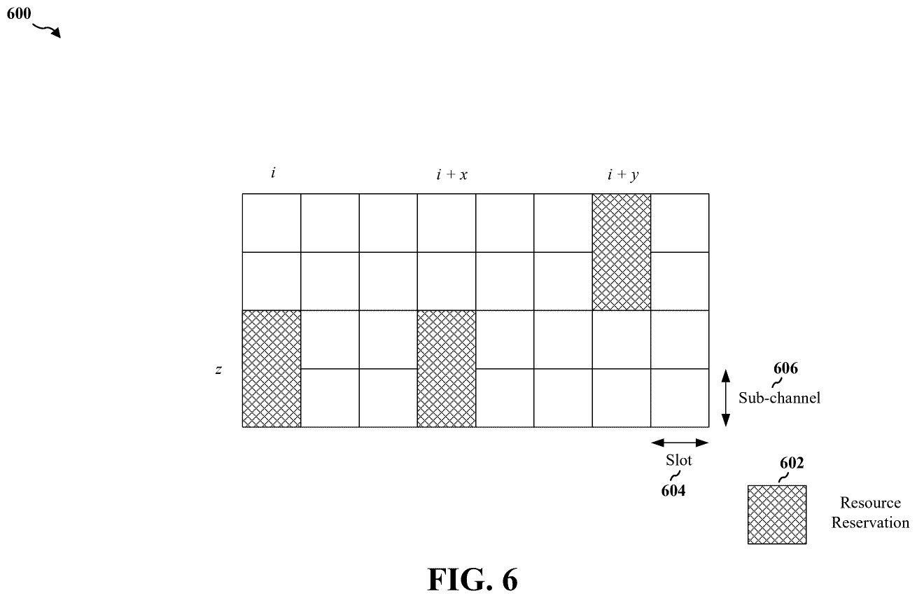

FIG. 6 illustrates an example of a resource pool 600 including resource reservations 602 for a sidelink data transmission. Each resource reservation 602 may include a slot 604 and one or more subchannels 606. For example, the base station or Tx UE may configure a resource pool with three resource reservations such as illustrated in FIG. 6, with each resource reservation spanning one slot and two subchannels. The base station may configure the resource pool 600 and resource reservations 602 in DCI (in a mode 1 resource allocation), or the Tx UE may determine the resource pool 600 and resource reservations 602 autonomously (in a mode 2 resource allocation). The Tx UE may also indicate the resource pool 600 and resource reservations 602 in SCI-1 to a Rx UE. For instance, the Tx UE may transmit PSCCH including SCI-1 in slot i indicating that resource reservations for PSSCH are present in slots i, i+x, and i+y and each span a number of subcarriers z, with i, x, y, and z being configured values such as indicated for example in the following Table 1. These values are merely examples; the resource pool may be configured with a different number of resource reservations spanning a different number of slot(s) and subchannel(s) in other examples.

TABLE 1
Reservations Signaled by an SCI in slot i

| Reservation | # of Sub-channels | Slot |
|---|---|---|
| 1 | z | i |
| 2 | z | i + x: 0 < x < 31 |
| 3 | z | i + y: x < y ≤ 31 |

Thus, the Tx UE may transmit SCI-1 to indicate to the Rx UE the allocated resources for the PSSCH. Additionally, the Tx UE may transmit SCI-2 to indicate other information for the Rx UE to decode the PSSCH. For instance, SCI-2 may be front-loaded in PSSCH to indicate at least the following information: a HARQ process ID for the PSSCH whose number of bits depend on a number of HARQ processes, a new data indicator (NDI) having a fixed number of bits (e.g., 1 bit), a redundancy version identifier (RV-ID) having a fixed number of bits (e.g., 2 bits), a source identifier of the Tx UE having a fixed number of bits (e.g., 8 bits), a destination identifier of the Rx UE having a fixed number of bits (e.g., 16 bits), and a HARQ enable/disable flag having a fixed number of bits (e.g., 1 bit). Additionally, the SCI-2 may include other fields particular to the SCI-2 format. For example, SCI 2-A format may indicate a cast type for the PSSCH (broadcast, groupcast, unicast) having a fixed number of bits (e.g., 2 bits) and a CSI request flag having a fixed number of bits (e.g., 1 bit), and SCI 2-B format may indicate a zone identifier (e.g., 12 bits) and a communication range (e.g., 4 bits). The Rx UE and other sidelink UEs may determine this information to identify which UE(s) the Rx UEs, as well as to allow the Rx UE(s) to successfully decode the PSSCH in the allocated resources. In some aspects, for configured grants in sidelink communication for both type 1 and type 2, the HARQ Process ID associated with a first slot of a sidelink transmission may be derived from the following equation: HARQ Process ID=[floor (CURRENT_slot/sl-PeriodCG)]modulo sl-NrOfHARQ-Processes+sl-HARQ-ProcID-offset, where CURRENT_slot=(SFN×numberOfSlotsPerFrame+slot number in the frame), and numberOfSlotsPerFrame refers to the number of consecutive slots per frame.

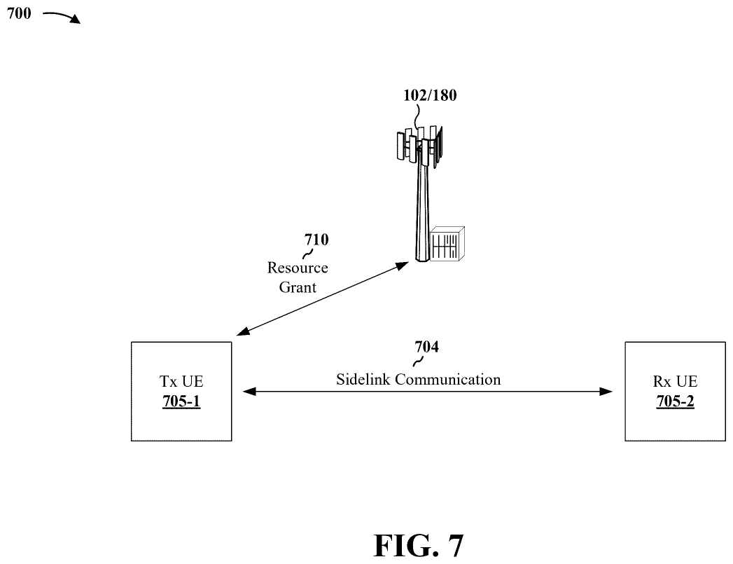

FIG. 7 is a diagram illustrating an example 700 of sidelink communications and access link communications, in accordance with various aspects of the present disclosure. As shown in FIG. 7, a transmitter (Tx) UE 702 and a receiver (Rx) UE 710 may communicate with one another via sidelink communication 704. As further shown, in some sidelink modes, a base station 102/180 may communicate with the Tx UE 702 via an access link. The Tx UE 702 and/or the Rx UE 706 may correspond to one or more UEs described elsewhere herein, such as the UE 104 of FIG. 1. Thus, a direct link between UEs 104 (e.g., via a PC5 interface) may be referred to as a sidelink, and a direct link between the base station 102/180 and a UE 104 (e.g., via a Uu interface) may be referred to as an access link. Sidelink communications may be transmitted via the sidelink, and access link communications may be transmitted via the access link. An access link communication may be either a downlink communication (from the base station 102/180 to a UE 104) or an uplink communication (from a UE 104 to a base station 102/180).

In mode 1 resource allocation, the base station 102/180 may provide a resource grant 710 to the Tx UE 702 indicating the resource allocation for sidelink communication 704. The resource grant 710 may be, for example, a dynamic grant (DG), a configured grant (CG) type 1, or a CG type 2. For a DG, the resource grant 710 may be a DCI, which the base station 102/180 provides aperiodically to the Tx UE 702 indicating the time-frequency resources for sidelink communication 704 on a slot by slot basis. For a CG type 1, the resource grant 710 may be an RRC configuration, which the base station 102/180 provides periodically to the Tx UE 702 indicating the time-frequency resources for sidelink communication 704 for a configured period of time or until a subsequent resource grant is transmitted. For a CG type 2, the resource grant 710 may be a DCI, which the base station 102/180 provides to the Tx UE 702 in order to activate a configured resource allocation for sidelink communication 704 for a configured period of time or until a subsequent resource grant is transmitted. The activated resource allocation may be configured in a RRC configuration similar to that for CG type 1. In either DGs or CGs, where the base station 102/180 provides DCI to the Tx UE 702 to allocate or activate the time-frequency resources, the DCI may include a specific DCI format 3_0 associated with mode 1 resource allocation. The DCI format may indicate the TDRA and FDRA of the sidelink resources, the transmission timing between reception of the resource grant 710 and transmission of the sidelink communication 704, and other information. The DCI may not configure a specific MCS for the sidelink communication; instead, the Tx UE may determine the MCS within a configured limit by the base station. After obtaining the resource allocation, the Tx UE 702 provides the sidelink communication 704 to the Rx UE 706 in the allocated resources.

In contrast, for a mode 2 resource allocation, the Tx UE 702 may not receive a resource grant from a base station allocating the resources for sidelink communication 754. Instead, the Tx UE 702 performs channel sensing and resource selection autonomously. For example, during channel sensing, the Tx UE 702 blindly decodes all PSCCH channels and determines the reserved resources by other sidelink transmissions. Upon determining the reserved resources, during resource selection, the Tx UE 702 reports the available resources to an upper layer of the Tx UE 702, which subsequently decides the resources to allocate to the sidelink communication 704. After selecting the resources, the Tx UE 702 may provide the sidelink communication 704 to the Rx UE 706 in the selected resources.

Sidelink communications may also be applicable to industrial internet of things (IIoT). In IIoT, a programmable logic controller (PLC) may directly communicate in sidelink with sensors or actuators to collect, exchange, and analyze data and to facilitate improvements in productivity, efficiency, or other benefits in industrial applications. Typically, IIOT traffic is deterministic with packets of 32 to 256 bytes (or other byte range), and since the bandwidth required for IIOT traffic is thus relatively low, a small number of RBs such as 2 RBs may be sufficient for data communication. Moreover, sensors and actuators may have UE capability constraints in terms of bandwidth and processing power, even though the overall bandwidth in dedicated frequency bands or unlicensed bands may be relatively large. Furthermore, sensors and actuators may not detect or monitor all transmissions in IIoT. Each of these traffic characteristics thus allows for sidelink communication to be an effective method of communication in IIoT.

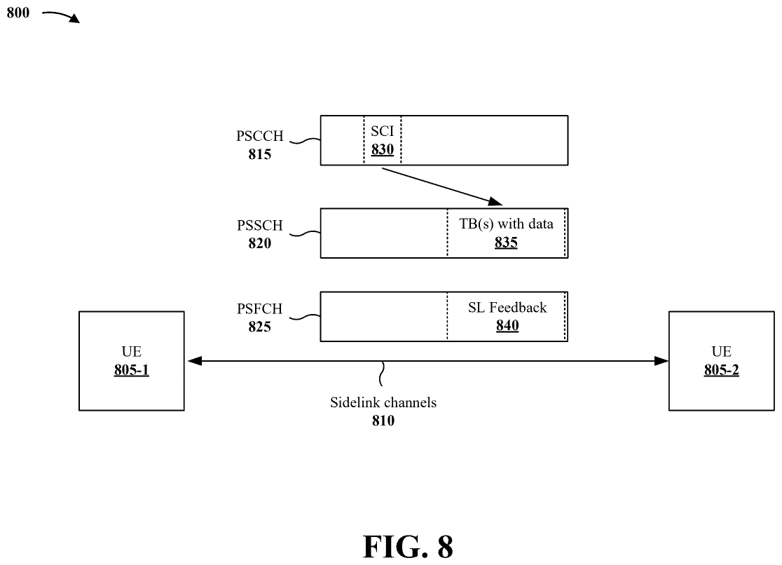

FIG. 8 is a diagram illustrating an example 800 of sidelink communications, in accordance with various aspects of the present disclosure. As shown in FIG. 8, a first UE 805-1 may communicate with a second UE 805-2 (and one or more other UEs 805) via one or more sidelink channels 810. The UEs 805-1 and 805-2 may communicate using the one or more sidelink channels 810 for P2P communications, D2D communications, V2X communications (e.g., which may include V2V communications, V2I communications, V2P communications, and/or the like), mesh networking, and/or the like. In some aspects, the UEs 805 (e.g., UE 805-1 and/or UE 805-2) may correspond to one or more other UEs described elsewhere herein, such as UE 120. In some aspects, the one or more sidelink channels 810 may use a PC5 interface and/or may operate in a high frequency band (e.g., the 8.9 GHz band). Additionally, or alternatively, the UEs 805 may synchronize timing of transmission time intervals (TTIs) (e.g., frames, subframes, slots, symbols, and/or the like) using global navigation satellite system (GNSS) timing.

As further shown in FIG. 8, the one or more sidelink channels 810 may include a physical sidelink control channel (PSCCH) 815, a physical sidelink shared channel (PSSCH) 820, and/or a physical sidelink feedback channel (PSFCH) 825. The PSCCH 815 may be used to communicate control information, similar to a physical downlink control channel (PDCCH) and/or a physical uplink control channel (PUCCH) used for cellular communications with a base station 102 via an access link or an access channel. The PSSCH 820 may be used to communicate data, similar to a physical downlink shared channel (PDSCH) and/or a physical uplink shared channel (PUSCH) used for cellular communications with a base station 102 via an access link or an access channel. For example, the PSCCH 815 may carry sidelink control information (SCI) 830, which may indicate various control information used for sidelink communications, such as one or more resources (e.g., time resources, frequency resources, spatial resources, and/or the like) where a transport block (TB) 835 may be carried on the PSSCH 820. The TB 835 may include data. The PSFCH 825 may be used to communicate sidelink feedback 840, such as hybrid automatic repeat request (HARQ) feedback (e.g., acknowledgement or negative acknowledgement (ACK/NACK) information), transmit power control (TPC), a scheduling request (SR), and/or the like.

In some aspects, the one or more sidelink channels 810 may use resource pools. For example, a scheduling assignment (e.g., included in SCI 830) may be transmitted in sub-channels using specific resource blocks (RBs) across time. In some aspects, data transmissions (e.g., on the PSSCH 820) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 805 may operate using a transmission mode where resource selection and/or scheduling is performed by the UE 805 (e.g., rather than a base station 102). For purposes of brevity, the UE 805 refers to one of the UE 805-1 or the 805-2, or to both collectively depending on implementation. In some aspects, the UE 805 may perform resource selection and/or scheduling by sensing channel availability for transmissions. For example, the UE 805 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 805 may perform resource selection and/or scheduling using SCI 830 received in the PSCCH 815, which may indicate occupied resources, channel parameters, and/or the like. Additionally, or alternatively, the UE 805 may perform resource selection and/or scheduling by determining a channel busy rate (CBR) associated with various sidelink channels, which may be used for rate control (e.g., by indicating a maximum number of resource blocks that the UE 805 can use for a particular set of subframes).

In the transmission mode where resource selection and/or scheduling is performed by a UE 805, the UE 805 may generate sidelink grants, and may transmit the grants in SCI 830. A sidelink grant may indicate, for example, one or more parameters (e.g., transmission parameters) to be used for an upcoming sidelink transmission, such as one or more resource blocks to be used for the upcoming sidelink transmission on the PSSCH 820 (e.g., for TBs 835), one or more subframes to be used for the upcoming sidelink transmission, a modulation and coding scheme (MCS) to be used for the upcoming sidelink transmission, and/or the like. In some aspects, a UE 805 may generate a sidelink grant that indicates one or more parameters for semi-persistent scheduling (SPS), such as a periodicity of a sidelink transmission. Additionally, or alternatively, the UE 805 may generate a sidelink grant for event-driven scheduling, such as for an on-demand sidelink message.

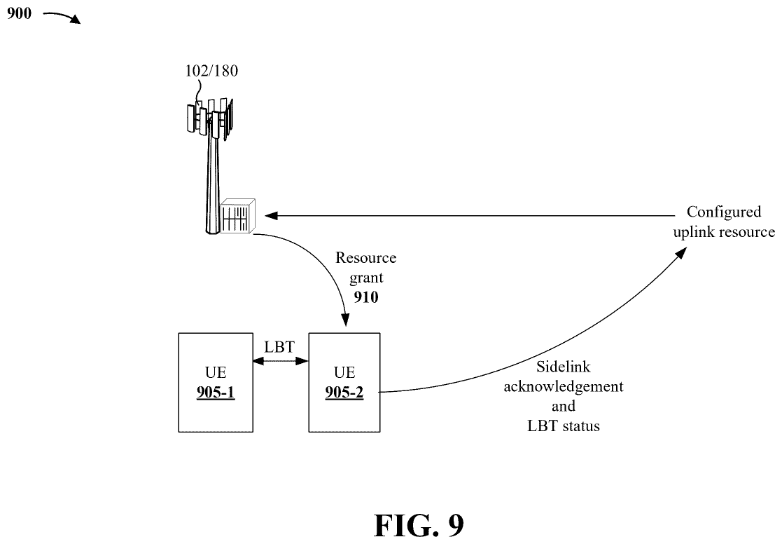

FIG. 9 is a diagram illustrating an example 900 of acknowledgement messages for sidelink channels, in accordance with various aspects of the present disclosure. In some aspects, a base station (e.g., base station 102) may transmit, and a UE (e.g., UE 905-2) may receive, a resource grant for at least one sidelink channel (e.g., as described above in connection with FIGS. 7 and 8). Accordingly, the UE 905-2 may communicate with one or more additional UEs (e.g., UE 905-1) on the at least one sidelink channel. In some aspects, the resource grant may include DCI, such as a format 3_0 DCI (e.g., as defined in 3GPP specifications and/or other standards).

In some aspects, the base station 102 may transmit, and the Tx UE 905-2 may receive, a resource grant 910 for the at least one sidelink channel. For example, as shown in FIG. 9, the resource grant 910 may include downlink control information (DCI), such as a format 3_0DCI (e.g., as defined in 3GPP specifications and/or other standards). The resource grant 910 may indicate one or more time resources (e.g., one or more symbols across one or more slots within one or more frames) for the Tx UE 905-2 to use on the at least one sidelink channel. Additionally, or alternatively, the resource grant 910 may indicate one or more frequency resources (e.g., one or more component carriers (CCs) to use on one or more subbands within one or more bandwidth parts (BWPs)) for the Tx UE 905-2 to use on the at least one sidelink channel.

As further shown in FIG. 9, the resource grant 910 may indicate an uplink resource (e.g., a resource on a PUCCH) such that the Tx UE 905-2 can report acknowledgement messages (e.g., ACK/NACK feedback and/or other HARQ feedback) received from the Rx UE 905-1 (e.g., on a PSFCH). In some aspects, the Tx UE 905-2 may copy the acknowledgement message received on the PSFCH to the PUCCH indicated by the resource grant 910. In one example, when the Tx UE 905-2 unicasts data (e.g., to the Rx UE 905-1 only), the Tx UE 905-2 may copy an acknowledgement message received on the PSFCH to the PUCCH and transmit a NACK feedback on the PUCCH when nothing is received on the PSFCH. In another example, when the Tx UE 905-2 groupcasts data (e.g., to a group of UEs including the Rx UE 905-1), the Tx UE 905-2 may transmit an ACK feedback on the PUCCH when an ACK message is received on all PSFCHs from the group of UEs and transmit a NACK feedback otherwise. In yet another example, when the Tx UE 905-2 performs zone-based transmission (e.g., to a geographical zone in which the Rx UE 905-1 is located), the Tx UE 905-2 may transmit a NACK feedback on the PUCCH when a NACK message is received on any PSFCH and transmit an ACK feedback otherwise.

In some aspects, the Tx UE 905-2 may use a listen-before-talk (LBT) procedure on the at least one sidelink channel. For example, the Tx UE 905-2 may wait for one or more symbols of a slot, and transmit (e.g., to the Rx UE 905-1) within that slot only when the Tx UE 905-2 did not decode a transmission in those one or more symbols. In some aspects, the Tx UE 905-2 may use the LBT procedure at least in part because the at least one sidelink channel is over an unlicensed band channel. For example, the at least one sidelink channel may use NR unlicensed (NR-U) spectrum.

Generally, the physical layer of the Tx UE 905-2 may report LBT statuses (e.g., passes or fails) to an upper layer of the Tx UE 905-2 (e.g., a medium access control (MAC) layer). The upper layer will filter and average the LBT statuses and report them to the base station 102 (e.g., using a MAC control element (MAC-CE)). However, this results in a delay between the Tx UE 905-2 detecting LBT statuses and reporting them to the base station 102. Moreover, the Tx UE 905-2 consumes additional processing resources by filtering and averaging the LBT statuses even though this results in the base station 102 receiving less accurate information about which subbands on the at least one sidelink channel should be reallocated.

Some techniques and apparatuses described herein allow a UE (e.g., UE 104 and/or UE 905-2) to report at least one status, associated with an LBT procedure, using an uplink channel (e.g., a PUCCH) configured by a base station (e.g., base station 102). Accordingly, the UE 905-2 may report LBT statuses to the base station 102 via PUCCH.

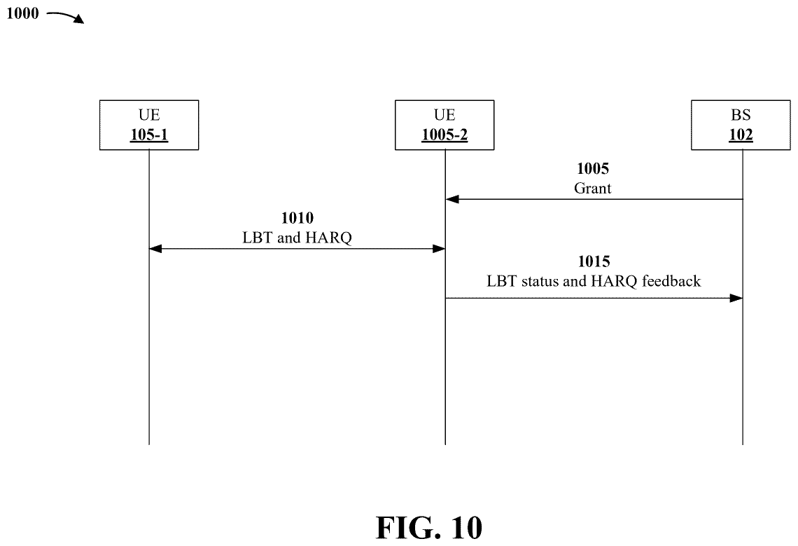

FIG. 10 is a diagram illustrating an example 1000 associated with LBT reporting for sidelink channels, in accordance with various aspects of the present disclosure. In some aspects, a base station (e.g., base station 102) may transmit, and a UE (e.g., UE 1005-2) may receive, a resource grant for at least one sidelink channel (e.g., as described above in connection with FIGS. 3 and 10). Accordingly, the UE 1005-2 may communicate with one or more additional UEs (e.g., UE 1005-1) on the at least one sidelink channel. In some aspects, the resource grant may include DCI, such as a format 3_0 DCI (e.g., as defined in 3GPP specifications and/or other standards).

As shown in FIG. 10, the resource grant may indicate an uplink resource for transmitting sidelink transmission acknowledgement messages. For example, the resource grant may indicate the uplink resource (e.g., a resource on a PUCCH) such that the UE 1005-2 can report acknowledgement messages (e.g., ACK/NACK feedback and/or other HARQ feedback) received from the UE 1005-1 (e.g., on a PSFCH as shown in example 1000).

In some aspects, the UE 1005-2 may use an LBT procedure on the at least one sidelink channel. For example, the UE 1005-2 may use the LBT procedure at least in part because the at least one sidelink channel is over an unlicensed band channel.

As further shown in FIG. 10, the UE 1005-2 may transmit, and the base station 102 may receive, on the uplink resource (e.g., on the PUCCH resource), an indication of at least one status associated with the LBT procedure used on the at least one sidelink channel. In some aspects, as described below in connection with FIG. 10, the indication may further be based at least in part on one or more sidelink transmission acknowledgement messages (e.g., received on the PSFCH). Accordingly, as described below in connection with FIG. 10, the indication of the at least one status may include two or more bits.

In some aspects, the UE 1005-2 may receive an additional resource grant for at least one additional sidelink channel. Additionally, the resource grant may indicate the uplink resource for transmitting sidelink transmission acknowledgement messages. Accordingly, multiple resource grants (e.g., format 3_0 DCI as defined in 3GPP specifications and/or other resource grants) may indicate the same uplink resource (e.g., the same PUCCH resource) for reporting acknowledgement messages (e.g., ACK/NACK feedback and/or other HARQ feedback) received from the UE 1005-1 (e.g., on a PSFCH as shown in example 1000).

In some aspects, the UE 1005-2 may use an LBT procedure on the at least one additional sidelink channel. For example, the UE 1005-2 may use the LBT procedure at least in part because the at least one additional sidelink channel is over an unlicensed band channel.

Accordingly, the UE 1005-2 may determine at least one additional status associated with the LBT procedure used on the at least one additional sidelink channel. Additionally, the UE 1005-2 may combine the at least one additional status with the at least one status (e.g., as described below in connection with FIG. 10) before transmitting on the uplink resource.

By using the technique described in connection with FIG. 10, the UE 1005-2 may report at least one status, associated with an LBT procedure, using an uplink channel (e.g., a PUCCH) configured by the base station 102. Accordingly, the UE 1005-2 may report LBT statuses to the base station 102 with reduced latency and while conserving processing resources. In addition, the base station 102 may receive more accurate LBT statuses from the UE 1005-2. Accordingly, the base station 102 may more effectively reallocate subbands on the at least one sidelink channel and thus improve quality and reliability of communications on the at least one sidelink channel.

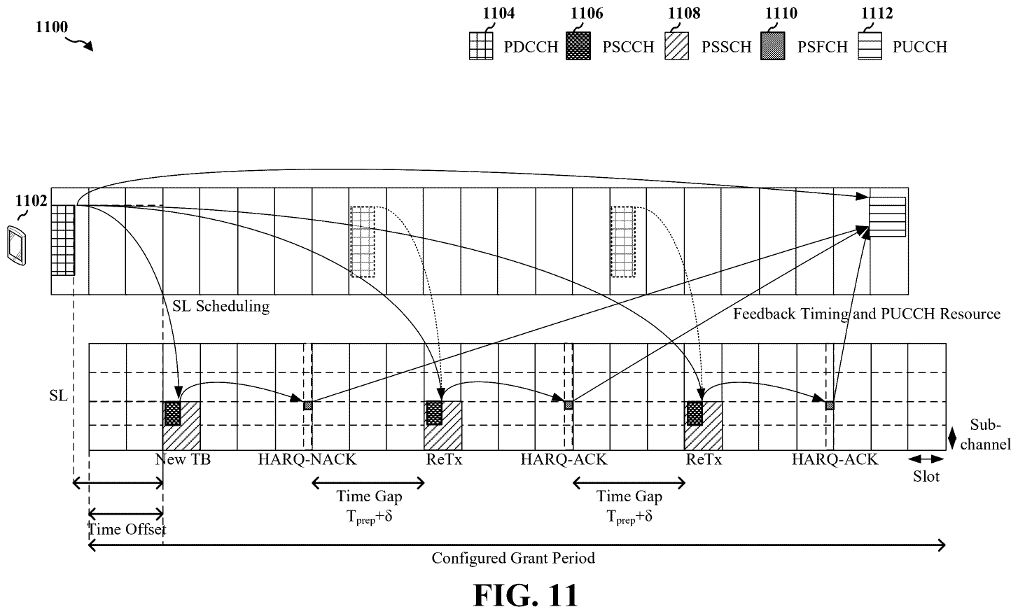

FIG. 11 illustrates an example 1100 of sidelink communication based on mode 1 resource allocation, in accordance with various aspects of the present disclosure. In the illustrated example, the base station may transmit to a Tx UE 1102 a PDCCH 1104 scheduling resources for PSCCH 1106, PSSCH 1108 and PSFCH 1110 in a plurality of resource reservations. While FIG. 11 illustrates the example where the resources are indicated in a DCI from the base station in the PDCCH 1104 for CG Type 2, the resources may alternatively be configured in an RRC configuration for CG Type 1. Moreover, the Tx UE 1102 may repeat the sidelink communication in each of the configured resources according to a time gap indicated in the DCI. For instance, in the example of FIG. 11 where the base station configures three resource reservations for the sidelink communication (e.g., initial transmission and two retransmissions), the Tx UE 1102 may communicate the sidelink data in three repetitions to the Rx UE beginning three slots after reception of the DCI. If the Rx UE fails to receive or decode the sidelink data transmissions, the Rx UE may provide a HARQ-ACK feedback to the Tx UE 1102 in PSFCH 1110, as illustrated in the example of FIG. 11. For example, as illustrated in FIG. 11, the Tx UE 1102 transmits the PSCCH 1106 and the PSSCH 1108 to the Rx UE, and determines that the Rx UE failed to receive or decode the PSSCH 1108 by way of the HARQ-ACK feedback from the Rx UE. In this regard, the Tx UE 1102 transmits a first retransmission of the PSSCH 1108 (along with the PSCCH 1106) to the Rx UE at a time instance after the PSFCH associated with the initial transmission. The time instance may be separated by a time gap. In one or more implementations, the time gap may be defined as T_prep+δ. After transmission of the retransmission, the Tx UE 1102 determines that the Rx UE failed to receive or decode the retransmission of the PSSCH 1108 by way of the HARQ-ACK feedback from the Rx UE. In this regard, the Tx UE 1102 transmits a second retransmission of the PSSCH 1108 (along with the PSCCH 1106) to the Rx UE at a time instance separated by the same time gap after the PSFCH associated with the first retransmission. In response to receiving the HARQ-ACK feedback associated with the second retransmission, the Tx UE 1102 may provide the HARQ-ACK feedback to the base station in a PUCCH 1112 according to a PSFCH to HARQ feedback timing and a PRI indicated in the DCI. For instance, in the example of FIG. 11, the Tx UE may provide the HARQ-ACK feedback to the base station in a configured resource of PUCCH 1112 after reception of the PSFCH 1110.

In some aspects, may dynamically configure each of the three resource reservations for the sidelink communication with a respective PDCCH. For example, the base station may again provide the DCI in the PDCCH 1104 to the UE to configure the Tx UE 1102 to retransmit the TB in the resource reservation allocated to the retransmission, as illustrated in the example of FIG. 11.

In some aspects, the Tx UE 1102 can be assigned a maximum of three sidelink data resources during each CG period. In an aspect, the resource grant indicates that only one sidelink data resource can be used for a new TB. The other sidelink data resources also can be used for retransmission of the new TB having been transmitted in a current CG period or a previous CG period. In some aspects, the resource grant may indicate that a second sidelink data resource is configured to be at a time gap after a PSFCH instance associated with the first sidelink data resource. In some aspects, the maximum number of retransmissions per TB may be associated with a priority of the TB.

The Tx UE 1102 can transmit HARQ-ACK feedback, such as an ACK/NACK report (if configured), in the PUCCH configured after the PSFCH associated with the last sidelink data resource allocated for each CG period. The HARQ-ACK feedback may correspond to one or more bits of the PUCCH 1112 to inform the base station about the success of the potentially last three sidelink data transmissions.

The ACK/NACK report may include information of the initial transmission and one or more retransmissions of the same TB. In some aspects, the Tx UE 1102 may report an ACK in the PUCCH 1112 only if all Rx UEs receive correctly at least one of the retransmissions and the Rx UEs positively acknowledge reception of the retransmissions to the Tx UE 1102. When the feedback report includes information of the transmission and retransmissions of different TBs, the Tx UE 1102 may only report an ACK if all Rx UEs receive correctly the different TBs and the Rx UEs positively acknowledge reception of the different TBs to the Tx UE 1102.

In sidelink mode 1 operation for the unlicensed spectrum, the NAK in the PUCCH 1112 does not reflect whether the negative acknowledgment is due to a LBT failure or a decoding failure. Legacy techniques described in FIGS. 9 and 10 provide for reporting the LBT failure directly to the base station reusing the PUCCH resource allocated for HARQ-ACK feedback reporting in the sidelink mode 1 operation. In some aspects, the L1-based LBT failure reporting may have smaller delay than the PUCCH legacy approach. The LBT status reporting may be configured on top of HARQ-ACK feedback. The LBT status reporting may be transmitted per subband or per group of subbands. The PUCCH resource granted by DCI 3_0 in sidelink mode 1 operation may be at a location assuming the scheduled PSSCH is transmitted and the corresponding PSFCH is received.

Some techniques and apparatuses described FIG. 11 allow the Tx UE 1102 to report at least one status, associated with an LBT procedure, using the PUCCH 1112 configured by a base station (e.g., base station 102). However, for unlicensed spectrum operation, sidelink transmission is subject to the LBT status, hence, multiple transmission opportunities for CG may be needed. In NR-U operation, the mechanisms used for both CG Type 1 and CG Type 2 can be extended so that the number of allocated slots following a time instance corresponding to an indicated configured grant offset can be configured to provide additional LBT opportunities. For example, the NR-U configuration may indicate (via the cg-nrofSlots parameter) the number of allocated slots in a configured grant periodicity following the time instance of configured grant offset, and also indicate (via the cg-nrofPUSCH-InSlot parameter) the number of consecutive PUSCH configured to CG within a slot, where the SLIV indicates the first PUSCH and additional PUSCH appended with the same length. For sidelink unlicensed (SL-U) operation, there exists a need to introduce additional LBT opportunities. Although the legacy sidelink operation provides for up to three sidelink data resources within one CG period, at least two sidelink data resources may need to be spaced out to allow PSFCH to be located in the middle for feedback.

In one or more implementations, the subject technology provides for extending the number of allocated slots following time instances corresponding to the TRIV-indicated timing offsets within a sidelink CG period of time for additional LBT opportunities.

FIG. 12 illustrates another example 1200 of sidelink communication based on mode 1 resource allocation, in accordance with various aspects of the present disclosure. Similar to the example of FIG. 11, in the illustrated example, the base station may transmit to a Tx UE 1202 a PDCCH 1204 scheduling resources for PSCCH 1206, PSSCH 1208 and PSFCH 1210 in multiple resource reservations. For CG Type 1 configuration, the TRIV may be included in the RRC via the sl-TimeResourceCG-Type1 parameter. For CG Type 2 configuration, the TRIV may be included in the DCI with format 3_0 for CG activation and/or re-activation. The TRIV may schedule the sidelink data resources with up to three slots for the initial transmission and retransmission(s). The Tx UE 1202 may repeat the sidelink communication in each of the configured resources according to a time gap indicated in the DCI. However, in this example, the Tx UE 1202 is configured with additional candidate transmission slots for each of the resource reservations. In one or more implementations, the subject technology provides for extending the number of allocated slots following time instances corresponding to the TRIV-indicated timing offsets within a sidelink CG period of time for additional LBT opportunities. In this example, the initial transmission may be configured with a set of transmission slots 1220. For example, the transmission slots 1220 includes a nominal slot for the initial transmission that carries the new TB along with three additional candidate transmission slots. In some aspects, the transmission slots 1220 includes contiguous slots. For example, the nominal slot and the three additional candidate transmission slots are contiguous to one another in time and/or frequency. In other aspects, the transmission slots 1220 includes non-contiguous slots. For example, the nominal slot and the three additional candidate transmission slots may be separated from one another in time and/or frequency. In an aspect, a subset of the transmission slots 1222 may be contiguous and another subset of the transmission slots 1222 may be non-contiguous.

In some aspects, all slots including the nominal slot and the additional slots afterwards are candidate transmission slots that allow for the additional LBT opportunities. If the Tx UE 1202 determines that the LBT procedure fails at the nominal slot, the Tx UE 1202 can continue additional LBT attempts using the additional slots after the nominal slot. By doing so, the Tx UE 1202 can increase the likelihood that the LBT is successful and reduces the number of occurrences of an LBT failure. In some aspects, when the Tx UE 1202 determines that the LBT is cleared and the PSCCH/PSSCH are transmitted, any additional slots may be left unused. In this example, the Tx UE 1202 determines that LBT fails in the nominal slot so it attempts LBT in the next slot (denoted as the first of three additional candidate transmission slots). The LBT clears in the additional slot, so the Tx UE 1202 attempts the transmission of the PSSCH 1208 during that slot. The two remaining candidate transmission slots can be left unused by the Tx UE 1202. For example, the Tx UE 1202 may refrain from attempting the LBT procedure at any one of the two remaining candidate transmission slots.

In one or more implementations, the number of additional slots allocated after the nominal slot is configurable. In some aspects, the number of additional slots may be configurable via RRC signaling for both CG Type 1 and CG Type 2. In some aspects, allowing additional slots for LBT opportunities can become additional overhead to the network. In this regard, the subject technology provides for more dynamic control over the number of additional slots. In some implementations, the LBT status reporting may be transmitted via the PUCCH 1212 back to the network. In this regard, for sidelink CG Type 2 operation, the base station may need to readjust the number of additional slot dynamically. For example, the number of additional slots for sidelink CG Type 2 operation may be configurable via DCI (e.g., DCI3_x) for CG activation and/or reactivation. In some aspects, the number of additional slots may be indicated in one or more DCI fields.

In this example, the Rx UE does not successfully decode the sidelink communication in the initial transmission, so the Rx UE may provide a HARQ-ACK feedback to the Tx UE 1202 in PSFCH 1210, as illustrated in the example of FIG. 12. In response to receiving the HARQ-ACK feedback indicating that the Rx UE failed to receive or decode the initial transmission of the PSSCH 1208, the Tx UE 1202 retransmits the prior sidelink data to the Rx UE by performing a retransmission of the PSSCH 1208 (along with the PSCCH 1206) at a time instance after the PSFCH associated with the initial transmission. In this example, the retransmission may be configured with a set of transmission slots 1222. For example, the transmission slots 1222 includes a nominal slot for the retransmission that carries the prior sidelink data along with three additional candidate transmission slots. The LBT clears in the nominal slot allocated to the retransmission, so the TX UE 1202 attempts the retransmission of the PSSCH 1208 during that slot. The three remaining candidate transmission slots can be left unused by the Tx UE 1202. The Tx UE 1202 may similarly provide the HARQ-ACK feedback to the base station in a PUCCH 1212 according to a PSFCH to HARQ feedback timing and a PRI indicated in the DCI. Accordingly, the Tx UE 1202 may report LBT statuses to the base station 102 with reduced latency and while conserving processing resources. In addition, the base station 102 receives more accurate LBT statuses from the Tx UE 1202. Accordingly, the base station 102 may more effectively reallocate subbands on one or more sidelink channels and thus improve quality and reliability of communications on those sidelink channels.

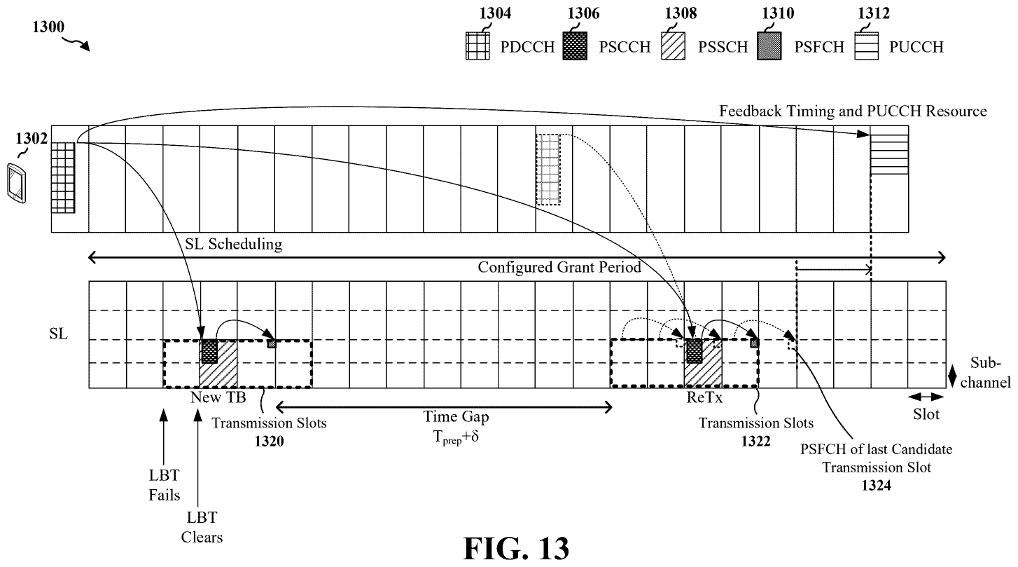

FIG. 13 illustrates another example 1300 of sidelink communication based on mode 1 resource allocation, in accordance with various aspects of the present disclosure. Similar to the example of FIG. 12, in the illustrated example, the base station may transmit to a Tx UE 1302 a PDCCH 1304 scheduling resources for PSCCH 1306, PSSCH 1308 and PSFCH 1310 in multiple resource reservations. In this example, the Rx UE does not successfully decode the sidelink communication in the initial transmission, so the Rx UE may provide a HARQ-ACK feedback to the Tx UE 1302 in PSFCH 1310, as illustrated in the example of FIG. 13. In response to receiving the HARQ-ACK feedback indicating that the Rx UE failed to receive or decode the initial transmission of the PSSCH 1308, the Tx UE 1302 retransmits the prior sidelink data to the Rx UE by performing a retransmission of the PSSCH 1308 (along with the PSCCH 1306) at a time instance after the PSFCH associated with the initial transmission. In this example, the retransmission may be configured with a set of transmission slots 1322. For example, the transmission slots 1322 includes a nominal slot for the retransmission that carries the prior sidelink data along with three additional candidate transmission slots. The LBT fails in the nominal slot as well as in the first additional candidate transmission slot, but finally clears in the second additional candidate transmission slot, so the TX UE 1302 attempts the retransmission of the PSSCH 1308 during that slot. The single remaining candidate transmission slot can be left unused by the Tx UE 1302.

The Tx UE 1302 can transmit HARQ-ACK feedback, such as an ACK/NACK report (if configured), in the PUCCH configured after the PSFCH associated with the last sidelink data resource allocated for each CG period of time. In the subject technology, additional candidate transmission slots are introduced for the last allocated sidelink data resource as may be indicated in the TRIV. In some aspects, each of the additional candidate transmission slots may be associated with a respective PSFCH opportunity.

However, there may be some uncertainty as to when the Tx UE 1302 may receive the ACK/NACK report from the Rx UE via PSFCH in the last allocated set of slots. To resolve this uncertainty, the subject technology provides for configuring the PUCCH to be transmitted after the PSFCH associated with last candidate transmission slot in the last allocated sidelink data resource indicated by the TRIV. In this example, the Tx UE 1302 may provide the HARQ-ACK feedback to the base station in a PUCCH 1312 after a PSFCH 1324, which is the PSFCH associated with the last candidate transmission slot. In some aspects, even with the PUCCH resource being allocated after the last possible PSFCH, the configured grant offset may be determined by the sl-PSFCH-ToPUCCH-CG-Type1-r16 parameter for CG Type1 and by the PSFCH-to-HARQ feedback timing DCI field for CG Type 2.

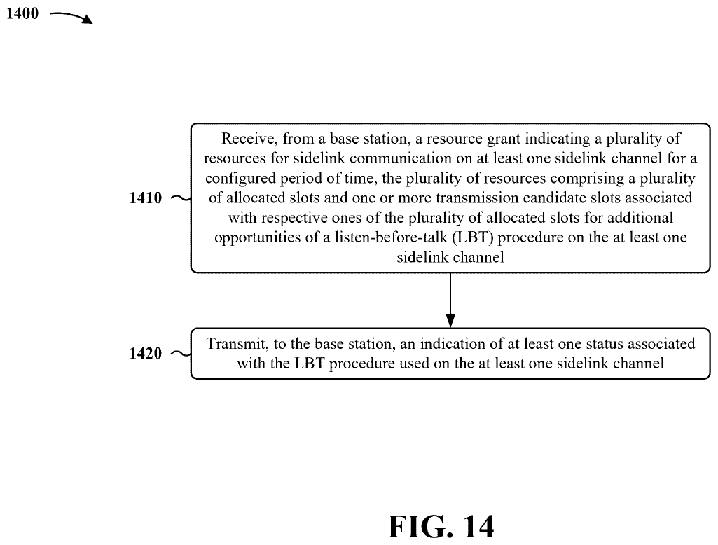

FIG. 14 is a flowchart of a process 1400 of wireless communication, in accordance with various aspects of the present disclosure. The process 1400 may be performed by a wireless communication device (e.g., the UE 104, 705-1, 705-2, 805-1, 805-2, 905-1, 905-2, 1005-1, 1005-2, 1102, 1202, 1302; the device 450, 480, the RSU 107; the apparatus 1602, which may include memory, a cellular baseband processor, and one or more components configured to perform the process 1400). As illustrated, the process 1400 includes a number of enumerated steps, but embodiments of the process 1400 may include additional steps before, after, and in between the enumerated steps. In some embodiments, one or more of the enumerated steps may be omitted or performed in a different order. Optional aspects are illustrated with a dashed line.

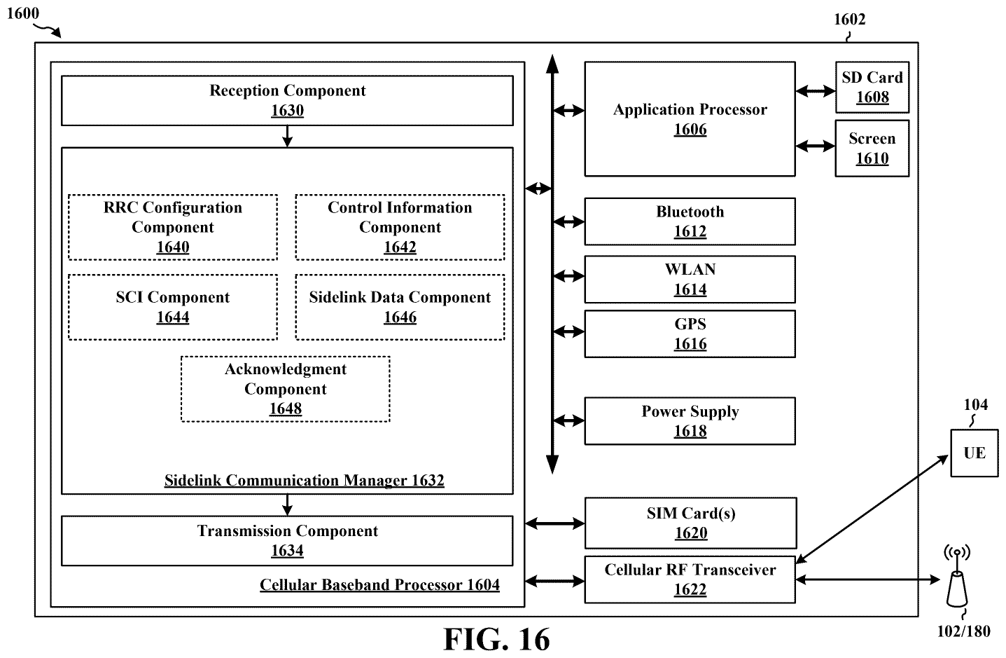

At 1410, a Tx UE may receive, from a base station, a resource grant indicating a plurality of resources for sidelink communication on at least one sidelink channel for a configured period of time, in which the plurality of resources includes a plurality of allocated slots and one or more candidate transmission slots associated with respective ones of the plurality of allocated slots for additional opportunities of a LBT procedure on the at least one sidelink channel. The resource grant involving RRC signaling may be received, e.g., by the RRC configuration component 1640 via the reception component 1630 of the apparatus 1602 in FIG. 16 for CG Type 1 configuration in some implementations. The resource grant involving DCI signaling may be received, e.g., by the control information component 1642 via the reception component 1630 of the apparatus 1602 in FIG. 16 for CG Type 2 configuration in other implementations. In some aspects, the at least one sidelink channel is over an unlicensed band channel (e.g., SL-U).

At 1420, the Tx UE may transmit, to the base station, an indication of at least one status associated with the LBT procedure used on the at least one sidelink channel. The indication of the at least one LBT procedure may be transmitted, e.g., by the sidelink communication manager 1632 via the transmission component 1634 of the apparatus 1602 in FIG. 16. In some aspects, the at least one status associated with the LBT procedure includes at least one of an LBT pass status or an LBT fail status.

Accordingly, the Tx UE may report LBT statuses to the base station with reduced latency and while conserving processing resources. In addition, the base station receives more accurate LBT statuses from the Tx UE. Accordingly, the base station may more effectively reallocate subbands on one or more sidelink channels and thus improve quality and reliability of communications on those sidelink channels.

In some aspects, the Tx UE may attempt the LBT procedure at a nominal slot of the plurality of allocated slots that is associated with a sidelink data transmission on the at least one sidelink channel. The Tx UE may determine whether the LBT procedure fails at the nominal slot, and attempt the LBT procedure using at least one of the one or more candidate transmission slots associated with the sidelink data transmission after the nominal slot based on the determination that the LBT procedure fails at the nominal slot.

In other aspects, the Tx UE may determine whether the LBT procedure fails at a first candidate transmission slot of the one or more candidate transmission slots, and attempts the LBT procedure using a second candidate transmission slot of the one or more candidate transmission slots associated with the sidelink data transmission after the first candidate transmission slot based on the determination that the LBT procedure fails at the first candidate transmission slot.

In some aspects, the Tx UE may determine that the LBT procedure does not fail using at least one of the one or more candidate transmission slots, and transmits sidelink data on the at least one sidelink channel. In an aspect, the Tx UE may refrain from attempting the LBT procedure at one or more remaining candidate transmission slots.

In some aspects, the Tx UE may receive, from the base station, downlink control information indicating an adjustment to a number of the one or more candidate transmission slots for configured grant type 2 operation based on the indication of at least one status associated with the LBT procedure used on the at least one sidelink channel.

In other aspects, the Tx UE may receive a TRIV that schedules the plurality of resources for the sidelink communication with up to three allocated slots of the plurality of allocated slots for an initial transmission and up to two retransmissions. In an aspect, the TRIV indicates a respective timing offset for each of the plurality of allocated slots within the configured period of time. In another aspect, the one or more candidate transmission slots follow time instances corresponding to the TRIV indicated timing offsets within the configured period of time. In an aspect, the TRIV is included in RRC signaling for configured grant type 1 configuration or configured grant type 2 configuration. In another aspect, the TRIV is included in a DCI message for configured grant type 2 configuration. In some aspects, the DCI dynamically configures a number of additional slots included in the one or more candidate transmission slots for configured grant activation or reactivation.

In some aspects, the Tx UE may transmit a PUCCH after a PSFCH associated with a last candidate transmission slot of a last allocated sidelink data resource indicated by the TRIV. In an aspect, the PUCCH includes the indication of the at least one status associated with the LBT procedure used on the at least one sidelink channel. In some aspects, each of the one or more candidate transmission slots is associated with a respective PSFCH opportunity.

A wireless apparatus may include components that perform each of the blocks of the algorithm in the aforementioned flowchart of FIG. 14. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus for wireless communication may include means for performing any of the blocks of the process described in connection with FIG. 14. The aforementioned means may be one or more of the aforementioned components of the apparatus and/or a processing system of the apparatus configured to perform the functions recited by the aforementioned means. The processing system may include the TX processor 468, the RX processor 456, and the controller/processor 459. As such, in one configuration, the aforementioned means may be the TX processor 468, the RX processor 456, and the controller/processor 459 configured to perform the functions recited by the aforementioned means.

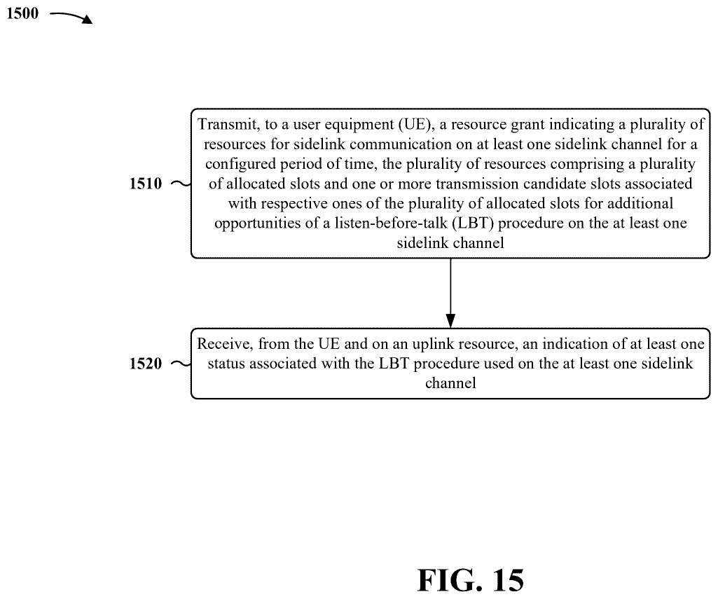

FIG. 15 is a flowchart of a process 1500 of wireless communication, in accordance with various aspects of the present disclosure. The process 1500 may be performed by a wireless communication device (e.g., the BS 102, 180; the device 410; the apparatus 1702, which may include memory, a cellular baseband processor, and one or more components configured to perform the process 1500). As illustrated, the process 1500 includes a number of enumerated steps, but embodiments of the process 1500 may include additional steps before, after, and in between the enumerated steps. In some embodiments, one or more of the enumerated steps may be omitted or performed in a different order. Optional aspects are illustrated with a dashed line.

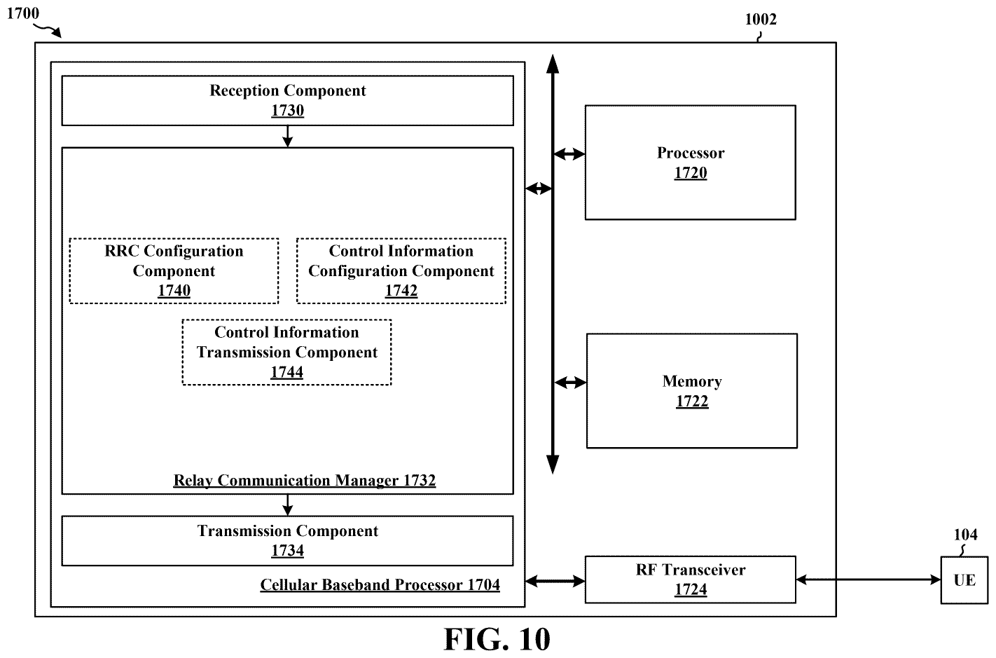

At 1510, the base station may transmitting, to a UE, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a LBT procedure on the at least one sidelink channel. The resource grant involving RRC signaling may be transmitted, e.g., by the RRC configuration component 1740 via the transmission component 1734 of the apparatus 1702 in FIG. 17. In other implementations, the resource grant involving DCI signaling may be transmitted, e.g., by the control information configuration component 1742 via the transmission component 1734 of the apparatus 1702 in FIG. 17.

At 1520, the base station may receive, from the UE, an indication of at least one status associated with the LBT procedure used on the at least one sidelink channel. The indication of the at least one status associated with the LBT procedure may be received, e.g., by the reception component 1730 of the apparatus 1702 in FIG. 17.

In some aspects, the base station may transmit, to the UE, downlink control information indicating an adjustment to a number of the one or more candidate transmission slots for configured grant type 2 operation based on the indication of at least one status associated with the LBT procedure used on the at least one sidelink channel.

In some aspects, the base station may transmit a TRIV that schedules the plurality of resources for the sidelink communication with up to three allocated slots of the plurality of allocated slots for an initial transmission and up to two retransmissions.

In some aspects, the base station may receive a PUCCH after a PSFCH associated with a last candidate transmission slot of a last allocated sidelink data resource indicated by the TRIV. In an aspect, the PUCCH includes the indication of the at least one status associated with the LBT procedure used on the at least one sidelink channel.

A wireless apparatus may include components that perform each of the blocks of the algorithm in the aforementioned flowchart of FIG. 15. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus for wireless communication may include means for performing any of the blocks of the process described in connection with FIG. 15. The aforementioned means may be one or more of the aforementioned components of the apparatus and/or a processing system of the apparatus configured to perform the functions recited by the aforementioned means. The processing system may include the TX processor 416, the RX processor 470, and the controller/processor 475. As such, in one configuration, the aforementioned means may be the TX processor 416, the RX processor 470, and the controller/processor 475 configured to perform the functions recited by the aforementioned means.

FIG. 16 is a diagram 1600 illustrating an example of a hardware implementation for an apparatus 1602, in accordance with various aspects of the present disclosure. The apparatus 1602 may be a UE or other wireless device that communicates based on sidelink (e.g., a Tx UE or a Rx UE). The apparatus 1602 includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with other wireless devices, such as a UE 164 and/or base station 162/180. The cellular baseband processor 1604 may include a computer-readable medium/memory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a sidelink communication manager 1632, and a transmission component 1634. The sidelink communication manager 1632 includes the one or more illustrated components. The components within the sidelink communication manager 1632 may be stored in the computer-readable medium/memory and/or configured as hardware within the cellular baseband processor 1604. The cellular baseband processor 1604 may be a component of the device 410 or 450 and may include the memory 460 or 476 and/or at least one of the TX processor 416 or 468, the RX processor 456 or 470, and the controller/processor 459 or 475. In one configuration, the apparatus 1602 may be a modem chip and include just the baseband processor 1604, and in another configuration, the apparatus 1602 may be the entire wireless device (e.g., see the device 410 or 450 of FIG. 4) and include the additional modules of the apparatus 1602.

The communication manager 1632 includes an RRC configuration component 1640 that is configured to receive a RRC configuration, e.g., as described in connection with 1410. The communication manager 1632 further includes a control information component 1642 that is configured to receive control information indicating a sidelink data resource for a configured grant period. In some aspects, the control information indicates a resource grant indicating a plurality of resources for sidelink communication on at least one sidelink channel for a configured period of time, in which the plurality of resources includes a plurality of allocated slots and one or more candidate transmission slots associated with respective ones of the plurality of allocated slots for additional LBT opportunities on the at least one sidelink channel. The communication manager 1632 further includes a SCI component 1644 that may receive input in the form of the sidelink data resource from the control information component 1642 and is configured to transmit SCI including a TRIV, where the TRIV indicates a resource allocation to schedule a set of sidelink data resources. For example, the TRIV may schedule the plurality of resources for the sidelink communication with up to three allocated slots of the plurality of allocated slots for an initial transmission and up to two retransmissions. The SCI component 1644 is also configured to transmit SCI to a second UE, where the SCI indicates to the second UE that each sidelink data resource is for a slot. The SCI component 1644 is also configured to transmit first-stage SCI and second-stage SCI to the UE, where either one of the first-stage SCI or the second-stage SCI indicates that downlink control information indicating an adjustment to a number of the one or more candidate transmission slots for configured grant type 2 operation based on the indication of at least one status associated with the LBT procedure used on the at least one sidelink channel. The communication manager 1632 further includes a sidelink data component 1646 that may receive input in the form of the sidelink data resource from the control information component 1642 and is configured to communicate sidelink data in the sidelink data resource with a second UE. The communication manager 1632 further includes an acknowledgment component 1648 that may receive input in the form of the control information from the control information component 1642 and is configured to transmit an acknowledgment of the control information including an indication of at least one status associated with the LBT procedure used on the at least one sidelink channel, e.g., as described in connection with 1420.

The apparatus 1602 may include additional components that perform each of the blocks of the algorithm in the aforementioned flowchart of FIG. 14. As such, each block in the aforementioned flowchart of FIG. 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for receiving, from a base station, a resource grant indicating a plurality of resources for sidelink communication on at least one sidelink channel for a configured period of time, in which the plurality of resources includes a plurality of allocated slots and one or more candidate transmission slots associated with respective ones of the plurality of allocated slots for additional opportunities of a LBT procedure on the at least one sidelink channel. The apparatus 1602 may also include means for transmitting, to the base station, an indication of at least one status associated with the LBT procedure used on the at least one sidelink channel.

The aforementioned means may be one or more of the aforementioned components of the apparatus 1602 configured to perform the functions recited by the aforementioned means. As described supra, the apparatus 1602 may include the TX Processor 416 or 468, the RX Processor 456 or 470, and the controller/processor 459 or 475. As such, in one configuration, the aforementioned means may be the TX Processor 416 or 468, the RX Processor 456 or 470, and the controller/processor 459 or 475 configured to perform the functions recited by the aforementioned means.

FIG. 17 is a diagram 1700 illustrating an example of a hardware implementation for an apparatus 1702, in accordance with various aspects of the present disclosure. The apparatus 1702 may be a base station or other wireless device that communicates based on downlink/uplink. The apparatus 1702 includes a cellular baseband processor 1704 (also referred to as a modem) coupled to a RF transceiver 1724, a processor 1720 and a memory 1722. The cellular baseband processor 1704 communicates through the RF transceiver 1724 with other wireless devices, such as a UE 174. The cellular baseband processor 1704 may include a computer-readable medium/memory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The processor 1720 is responsible for general processing, including the execution of software stored on the computer-readable medium/memory 1722. The software, when executed by the processor 1720, causes the apparatus 1702 to perform the various functions described supra for any particular apparatus. The computer-readable medium/memory 1722 may also be used for storing data that is manipulated by the processor 1720 when executing software. The cellular baseband processor 1704 further includes a reception component 1730, a relay communication manager 1732, and a transmission component 1734. The relay communication manager 1732 includes the one or more illustrated components. The components within the relay communication manager 1732 may be stored in the computer-readable medium/memory and/or configured as hardware within the cellular baseband processor 1704. The cellular baseband processor 1704 may be a component of the device 410 and may include the memory 476 and/or at least one of the TX processor 416, the RX processor 470, and the controller/processor 475. In one configuration, the apparatus 1702 may be a modem chip and include just the baseband processor 1704, and in another configuration, the apparatus 1702 may be the entire wireless device (e.g., see the device 410 of FIG. 4) and include the additional modules of the apparatus 1702.

The communication manager 1732 includes an RRC configuration component 1740 that is configured to transmit a RRC configuration, e.g., as described in connection with 1510. The communication manager 1732 further includes a control information configuration component 1742 that is configured to configure control information indicating a resource grant indicating a plurality of resources for sidelink communication on at least one sidelink channel for a configured period of time, in which the plurality of resources includes a plurality of allocated slots and one or more candidate transmission slots associated with respective ones of the plurality of allocated slots for additional LBT opportunities, e.g., as described in connection with 1510. In some aspects, the control information configuration component 1742 may be configured to configure the control information dynamically via DCI (e.g., DCI 3_0). For example, the control information configuration component 1742 may include in the DCI an adjustment to a number of the one or more candidate transmission slots for configured grant type 2 operation based on the indication of at least one status associated with the LBT procedure used on the at least one sidelink channel. The communication manager 1732 further includes a control information transmission component 1744 that may receive input in the form of the sidelink data resource from the control information configuration component 1742 and is configured to transmit the control information to a UE. The communication manager 1732 may further receive, from the UE, via the reception component 1730, an indication of at least one status associated with the LBT procedure used on the at least one sidelink channel, e.g., as described in connection with 1520.

The apparatus 1702 may include additional components that perform each of the blocks of the algorithm in the aforementioned flowchart of FIG. 15. As such, each block in the aforementioned flowchart of FIG. 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the cellular baseband processor 1704, includes means for transmitting, to a UE, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a LBT procedure on the at least one sidelink channel. The apparatus 1702 may further include means for receiving, from the UE and on an uplink resource, an indication of at least one status associated with the LBT procedure used on the at least one sidelink channel.

The aforementioned means may be one or more of the aforementioned components of the apparatus 1702 configured to perform the functions recited by the aforementioned means. As described supra, the apparatus 1702 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

The following aspects are illustrative only and aspects thereof may be combined with aspects of other examples or teaching described herein, without limitation.

Aspect 1 is a method of wireless communication performed by a user equipment that includes receiving, from a base station, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel; and transmitting, to the base station, an indication of at least one status associated with the LBT procedure used on the at least one sidelink channel.

In Aspect 2, the method of Aspect 1 further includes attempting the LBT procedure at a nominal slot of the plurality of allocated slots that is associated with a sidelink data transmission on the at least one sidelink channel; determining whether the LBT procedure fails at the nominal slot; and attempting the LBT procedure using at least one of the one or more candidate transmission slots associated with the sidelink data transmission after the nominal slot based on the determination that the LBT procedure fails at the nominal slot.

In Aspect 3, the method of Aspect 2 further includes determining whether the LBT procedure fails at a first candidate transmission slot of the one or more candidate transmission slots; and attempting the LBT procedure using a second candidate transmission slot of the one or more candidate transmission slots associated with the sidelink data transmission after the first candidate transmission slot based on the determination that the LBT procedure fails at the first candidate transmission slot.

In Aspect 4, the method of any of Aspects 1-3 further includes determining that the LBT procedure does not fail using at least one of the one or more candidate transmission slots; transmitting sidelink data on the at least one sidelink channel; and refraining from attempting the LBT procedure at one or more remaining candidate transmission slots.

In Aspect 5, the method of any of Aspects 1-4 further includes receiving, from the base station, downlink control information indicating an adjustment to a number of the one or more candidate transmission slots for configured grant type 2 operation based on the indication of at least one status associated with the LBT procedure used on the at least one sidelink channel.

In Aspect 6, the method of any of Aspects 1-5 further includes that the receiving the resource grant comprises receiving a time resource indication value (TRIV) that schedules the plurality of resources for the sidelink communication with up to three allocated slots of the plurality of allocated slots for an initial transmission and up to two retransmissions.

In Aspect 7, the method of Aspect 6 further includes that the TRIV indicates a respective timing offset for each of the plurality of allocated slots within the configured period of time.

In Aspect 8, the method of Aspect 6 further includes that the one or more candidate transmission slots follow time instances corresponding to the TRIV indicated timing offsets within the configured period of time.

In Aspect 9, the method of Aspect 6 further includes that the TRIV is included in radio resource control (RRC) signaling for configured grant type 1 configuration or configured grant type 2 configuration.

In Aspect 10, the method of Aspect 6 further includes that the TRIV is included in a downlink control information (DCI) message for configured grant type 2 configuration.

In Aspect 11, the method of Aspect 10 further includes that the DCI dynamically configures a number of additional slots included in the one or more candidate transmission slots for configured grant activation or reactivation.

In Aspect 12, the method of Aspect 6 further includes that the transmitting comprises transmitting a physical uplink control channel (PUCCH) after a physical sidelink feedback channel (PSFCH) associated with a last candidate transmission slot of a last allocated sidelink data resource indicated by the TRIV, the PUCCH comprising the indication of the at least one status associated with the LBT procedure used on the at least one sidelink channel.

In Aspect 13, the method of Aspects 1-12 further includes that each of the one or more candidate transmission slots is associated with a respective physical sidelink feedback channel (PSFCH) opportunity.

In Aspect 14, the method of Aspects 1-13 further includes that the at least one sidelink channel is over an unlicensed band channel.

In Aspect 15, the method of Aspects 1-14 further includes that the at least one status associated with the LBT procedure includes at least one of an LBT pass status or an LBT fail status.

Aspect 16 is a device including one or more processors and one or more memories in electronic communication with the one or more processors storing instructions executable by the one or more processors to cause the device to implement a method as in any of Aspects 1-15.

Aspect 17 is a system or apparatus including means for implementing a method or realizing an apparatus as in any of Aspects 1-15.

Aspect 18 is a non-transitory computer readable medium storing instructions executable by one or more processors to cause the one or more processors to implement a method as in any of Aspects 1-15.

Aspect 19 is a method of wireless communication performed by a base station that includes transmitting, to a user equipment (UE), a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel; and receiving, from the UE, an indication of at least one status associated with the LBT procedure used on the at least one sidelink channel.

In Aspect 20, the method of Aspect 19 further includes transmitting, to the UE, downlink control information indicating an adjustment to a number of the one or more candidate transmission slots for configured grant type 2 operation based on the indication of at least one status associated with the LBT procedure used on the at least one sidelink channel.

In Aspect 21, the method of any of Aspects 19 or 20 further includes that the transmitting the resource grant comprises transmitting a time resource indication value (TRIV) that schedules the plurality of resources for the sidelink communication with up to three allocated slots of the plurality of allocated slots for an initial transmission and up to two retransmissions.

In Aspect 22, the method of any of Aspects 19-21 further includes that the receiving comprises receiving a physical uplink control channel (PUCCH) after a physical sidelink feedback channel (PSFCH) associated with a last candidate transmission slot of a last allocated sidelink data resource indicated by the TRIV, the PUCCH comprising the indication of the at least one status associated with the LBT procedure used on the at least one sidelink channel.

Aspect 23 is a device including one or more processors and one or more memories in electronic communication with the one or more processors storing instructions executable by the one or more processors to cause the device to implement a method as in any of Aspects 19-22.

Aspect 24 is a system or apparatus including means for implementing a method or realizing an apparatus as in any of Aspects 19-22.

Aspect 25 is a non-transitory computer readable medium storing instructions executable by one or more processors to cause the one or more processors to implement a method as in any of Aspects 19-22.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication performed by a user equipment (UE), comprising:
receiving, from a base station, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel; and
transmitting, to the base station, an indication of at least one status associated with the LBT procedure used on the at least one sidelink channel.

2. The method of claim 1, further comprising:
attempting the LBT procedure at a nominal slot of the plurality of allocated slots that is associated with a sidelink data transmission on the at least one sidelink channel;
determining whether the LBT procedure fails at the nominal slot; and
attempting the LBT procedure using at least one of the one or more candidate transmission slots associated with the sidelink data transmission after the nominal slot based on the determination that the LBT procedure fails at the nominal slot.

3. The method of claim 2, further comprising:
determining whether the LBT procedure fails at a first candidate transmission slot of the one or more candidate transmission slots; and
attempting the LBT procedure using a second candidate transmission slot of the one or more candidate transmission slots associated with the sidelink data transmission after the first candidate transmission slot based on the determination that the LBT procedure fails at the first candidate transmission slot.

4. The method of claim 1, further comprising:
determining that the LBT procedure does not fail using at least one of the one or more candidate transmission slots;
transmitting sidelink data on the at least one sidelink channel; and
refraining from attempting the LBT procedure at one or more remaining candidate transmission slots.

5. The method of claim 1, further comprising receiving, from the base station, downlink control information indicating an adjustment to a number of the one or more candidate transmission slots for configured grant type 2 operation based on the indication of at least one status associated with the LBT procedure used on the at least one sidelink channel.

6. The method of claim 1, wherein the receiving the resource grant comprises receiving a time resource indication value (TRIV) that schedules the plurality of resources for the sidelink communication with up to three allocated slots of the plurality of allocated slots for an initial transmission and up to two retransmissions.

7. The method of claim 6, wherein the TRIV indicates a respective timing offset for each of the plurality of allocated slots within the configured period of time.

8. The method of claim 6, wherein the one or more candidate transmission slots follow time instances corresponding to the TRIV indicated timing offsets within the configured period of time.

9. The method of claim 6, wherein the TRIV is included in radio resource control (RRC) signaling for configured grant type 1 configuration or configured grant type 2 configuration.

10. The method of claim 6, wherein the TRIV is included in a downlink control information (DCI) message for configured grant type 2 configuration.

11. The method of claim 10, wherein the DCI dynamically configures a number of additional slots included in the one or more candidate transmission slots for configured grant activation or reactivation.

12. The method of claim 6, wherein the transmitting comprises transmitting a physical uplink control channel (PUCCH) after a physical sidelink feedback channel (PSFCH) associated with a last candidate transmission slot of a last allocated sidelink data resource indicated by the TRIV, the PUCCH comprising the indication of the at least one status associated with the LBT procedure used on the at least one sidelink channel.

13. The method of claim 1, wherein each of the one or more candidate transmission slots is associated with a respective physical sidelink feedback channel (PSFCH) opportunity.

14. The method of claim 1, wherein the at least one sidelink channel is over an unlicensed band channel.

15. The method of claim 1, wherein the at least one status associated with the LBT procedure includes at least one of an LBT pass status or an LBT fail status.

16. A method of wireless communication performed by a base station, comprising:
transmitting, to a user equipment (UE), a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel; and
receiving, from the UE, an indication of at least one status associated with the LBT procedure used on the at least one sidelink channel.

17. The method of claim 16, further comprising transmitting, to the UE, downlink control information indicating an adjustment to a number of the one or more candidate transmission slots for configured grant type 2 operation based on the indication of at least one status associated with the LBT procedure used on the at least one sidelink channel.

18. The method of claim 16, wherein the transmitting the resource grant comprises transmitting a time resource indication value (TRIV) that schedules the plurality of resources for the sidelink communication with up to three allocated slots of the plurality of allocated slots for an initial transmission and up to two retransmissions.

19. The method of claim 18, wherein the receiving comprises receiving a physical uplink control channel (PUCCH) after a physical sidelink feedback channel (PSFCH) associated with a last candidate transmission slot of a last allocated sidelink data resource indicated by the TRIV, the PUCCH comprising the indication of the at least one status associated with the LBT procedure used on the at least one sidelink channel.

20. An apparatus for wireless communication at a user equipment (UE), the apparatus comprising:
at least one processor; and
a memory, coupled to the at least one processor, storing code executable by the at least one processor to cause the apparatus to:
receive, from a base station, a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel; and
transmit, to the base station, an indication of at least one status associated with the LBT procedure used on the at least one sidelink channel.

21. The apparatus of claim 20, wherein the code executed by the at least one processor further causes the apparatus to:
attempt the LBT procedure at a nominal slot of the plurality of allocated slots that is associated with a sidelink data transmission on the at least one sidelink channel;
determine whether the LBT procedure fails at the nominal slot; and
attempt the LBT procedure using at least one of the one or more candidate transmission slots associated with the sidelink data transmission after the nominal slot based on the determination that the LBT procedure fails at the nominal slot.

22. The apparatus of claim 21, wherein the code executed by the at least one processor further causes the apparatus to:
determine whether the LBT procedure fails at a first candidate transmission slot of the one or more candidate transmission slots; and
attempt the LBT procedure using a second candidate transmission slot of the one or more candidate transmission slots associated with the sidelink data transmission after the first candidate transmission slot based on the determination that the LBT procedure fails at the first candidate transmission slot.

23. The apparatus of claim 20, wherein the code executed by the at least one processor further causes the apparatus to:
determine that the LBT procedure does not fail using at least one of the one or more candidate transmission slots;
transmit sidelink data on the at least one sidelink channel; and
refrain from attempting the LBT procedure at one or more remaining candidate transmission slots.

24. The apparatus of claim 20, wherein the code executed by the at least one processor further causes the apparatus to receive, from the base station, downlink control information indicating an adjustment to a number of the one or more candidate transmission slots for configured grant type 2 operation based on the indication of at least one status associated with the LBT procedure used on the at least one sidelink channel.

25. The apparatus of claim 20, wherein the code executed by the at least one processor that causes the apparatus to receive the resource grant further causes the apparatus to receive a time resource indication value (TRIV) that schedules the plurality of resources for the sidelink communication with up to three allocated slots of the plurality of allocated slots for an initial transmission and up to two retransmissions.

26. The apparatus of claim 25, wherein the code executed by the at least one processor that causes the apparatus to transmit further causes the apparatus to transmit a physical uplink control channel (PUCCH) after a physical sidelink feedback channel (PSFCH) associated with a last candidate transmission slot of a last allocated sidelink data resource indicated by the TRIV, the PUCCH comprising the indication of the at least one status associated with the LBT procedure used on the at least one sidelink channel.

27. An apparatus for wireless communication at a base station, the apparatus comprising:
at least one processor; and
a memory, coupled to the at least one processor, storing code executable by the at least one processor to cause the apparatus to:
transmit, to a user equipment (UE), a resource grant indicating a plurality of resources for sidelink communication on at least one sidelink channel for a configured period of time, the plurality of resources comprising a plurality of allocated slots and one or more candidate transmission slots associated with respective ones of the plurality of allocated slots for additional opportunities of a listen-before-talk (LBT) procedure on the at least one sidelink channel; and
receive, from the UE, an indication of at least one status associated with the LBT procedure used on the at least one sidelink channel.

28. The apparatus of claim 27, wherein the code executed by the at least one processor further causes the apparatus to transmit, to the UE, downlink control information indicating an adjustment to a number of the one or more candidate transmission slots for configured grant type 2 operation based on the indication of at least one status associated with the LBT procedure used on the at least one sidelink channel.

29. The apparatus of claim 27, wherein the code executed by the at least one processor that causes the apparatus to transmit the resource grant further causes the apparatus to transmit a time resource indication value (TRIV) that schedules the plurality of resources for the sidelink communication with up to three allocated slots of the plurality of allocated slots for an initial transmission and up to two retransmissions.

30. The apparatus of claim 29, wherein the code executed by the at least one processor that causes the apparatus to receive further causes the apparatus to receive a physical uplink control channel (PUCCH) after a physical sidelink feedback channel (PSFCH) associated with a last candidate transmission slot of a last allocated sidelink data resource indicated by the TRIV, the PUCCH comprising the indication of the at least one status associated with the LBT procedure used on the at least one sidelink channel.
